(19) United States
(12) Patent Application Publication
(10) Pub. No.: US 2025/0022006 A1
(43) Pub. Date: Jan. 16, 2025

(54) ANYTIME VALID CONFIDENCE SEQUENCE FOR RELATIVE INCREMENT IN ONLINE TESTS

(71) Applicant: Adobe Inc., San Jose, CA (US)

(72) Inventors: Ziao Liu, San Jose, CA (US); Ritwik Sinha, San Jose, CA (US); Raghavendra Addanki, San Jose, CA (US); David Arbour, San Jose, CA (US); Akash Maharaj, San Jose, CA (US)

(73) Assignee: Adobe Inc., San Jose, CA (US)

(21) Appl. No.: 18/220,496

(22) Filed: Jul. 11, 2023

(51) Int. Cl. G06Q 30/0242

(52) U.S. Cl. CPC G06Q 30/0243; G06Q 30/0277

(57) ABSTRACT

A method, a system, and a computer program product for analyzing data collected during a randomized controlled experiment to determine an effect of variations of digital content. Determination of the effect includes execution of first and second testing sequences that prompt responses to first and second digital contents, respectively, from users. The testing sequences execute during a predetermined duration of time. Responses to the first and second testing sequences generate first and second test data, respectively. One or more confidence intervals for each first and second test data are generated at a randomly selected time during the predetermined duration of time. A testing metric indicating the effect of the second digital content over the first digital content is determined at the randomly selected time. The testing metric is determined at any time before expiration of the predetermined duration of time.

### BACKGROUND

A/B testing (also referred to as randomized experimentation) has become universal in the optimization of digital experiences on websites, mobile applications, and in emails. Rapid growth and commoditization of experimentation platforms has made it easier than ever for developers, product managers, marketers, analysts, designers, and business leaders to use A/B testing tools. This has led to the growth of data-driven decision-making within organizations. However, it also meant that practitioners with less experience with the nuances of statistical inference have access to powerful tools that could lead them astray if used improperly. This democratization of A/B tests calls for procedures that meet the needs of practitioners, while also protecting them from statistically flawed conclusions. Practitioners often want to monitor tests continually, stop tests early, or continue tests to collect more evidence. However, such “peeking” or “early stopping” is known to inflate type-I error in naive fixed horizon methodologies. In a classical fixed-horizon A/B test the user must: (1) specify a hypothesis, (2) select a sample size (often based on minimum detectable effects (MDE) and the desired type-I and type-II error), and (3) only when the pre-specified sample size is reached, compare the p-value (or confidence interval) to the appropriate threshold. Performing comparisons multiple times before reaching the sample size, or collecting more data and performing additional comparisons drastically inflates the type-I error.

### SUMMARY

Some embodiments of the current subject matter generally relate to execution of an analysis of data being collected during a randomized controlled experiment, such as, an A/B test, to determine an “effect metric” or a “lift metric” (terms used interchangeably herein) at any time during execution of such experiment to determine an effect of one variation of digital content over another variation of that digital content (or another digital content). Non-limiting examples of such digital content include videos, audios, tests, graphics, websites, advertising campaigns, emails, and any other digital content. The determination of such metric involves execution of testing sequencies during a certain period of time. At least one sequence represents a “control” or part “A” of the A/B test and at least another sequence represents a “treatment” or part “B” of the test. The sequences prompt users to provide responses to variations of the digital content, where responses are collected as test data. The current subject matter allows random selection of a time during execution of the testing sequences, and, once such time is selected, generates confidence intervals for each collected test data. Confidence intervals are bounded by respective upper and lower bounds of the collected test data for each of the testing sequences. Further, determination of the metric then involves determination of effect intervals having bounds derived from the bounds of the confidence intervals. In an embodiment, a lower bound of an effect interval corresponds to a ratio of a lower bound of a confidence interval for the test data collected for the treatment part and an upper bound of a confidence interval for the test data collected for the control part. An upper bound of such effect interval corresponds to a ratio of an upper bound of the confidence interval for the test data collected for the treatment part and a lower bound of the confidence interval for the test data collected for the control part. The effect interval bounds bound the effect metric. The effect metric can represent a superiority, an inferiority, and/or no change of one variation digital content over another.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example system for execution of testing designed to ascertain users' responses/reactions/etc. to variations of digital content, in accordance with one embodiment of the current subject matter;

FIG. 2 illustrates an aspect of the subject matter in accordance with one embodiment;

FIG. 3 illustrates an aspect of the subject matter in accordance with one embodiment;

FIG. 4 illustrates an aspect of the subject matter in accordance with one embodiment;

FIG. 5A illustrates an aspect of the subject matter in accordance with one embodiment;

FIG. 5B illustrates an aspect of the subject matter in accordance with one embodiment;

FIG. 6 illustrates an aspect of the subject matter in accordance with one embodiment;

FIG. 7 illustrates an aspect of the subject matter in accordance with one embodiment;

FIG. 8 illustrates an aspect of the subject matter in accordance with one embodiment;

FIG. 9 illustrates an example process for determining a lift metric to an effect of a variant of digital content over another variant in accordance with one embodiment;

FIG. 10 illustrates another example process for determining a lift metric to an effect of a variant of digital content over another variant in accordance with one embodiment;

FIG. 11 illustrates another example process for determining a lift metric to an effect of a variant of digital content over another variant in accordance with one embodiment;

FIG. 12 illustrates an example computer-readable storage medium in accordance with one embodiment;

FIG. 13 illustrates an example computing architecture in accordance with one embodiment; and

FIG. 14 illustrates an example communications architecture in accordance with one embodiment.

### DETAILED DESCRIPTION

A/B testing (or “bucket testing”, “split-run testing”, “split testing”) is a simple randomized controlled experiment that may be used to ascertain behaviors of users in response to various content (e.g., digital content). A/B tests are useful to understand engagement and satisfaction of users as they relate to various online features (e.g., new digital features, new products, etc.). Many companies use A/B tests to assess and/or ensure that user experiences with their products are more successful and to streamline services offerings to users. Adobe, Inc., San Jose, CA, USA offers various products, including Adobe Target and Marketo®, Adobe Experience Platform (AEP) and others, that include various features that can be used to ascertain user's experience and/or satisfaction, such as through use of A/B testing.

As used herein, “A/B test”, “test”, “A/B experiment”, “experiment” or any variations thereof refer to an algorithm, such as, a computing algorithm that includes, but is not limited to, corresponding source code, object code, and/or any other code, when, when executed, causes presentation of various content, such as, but is not limited to, digital content, on one or more computing devices and prompts responses to such digital from one or more users of such computing devices, where responses include, but are not limited to, clicking, selecting, moving, removing/deleting, modifying, extracting, downloading, uploading, and/or performing any other computing action.

As used herein, an “effect metric”, a “lift metric” or any variations thereof refer to an effect one digital content has vis-à-vis another digital content, where digital contents can be variations of one another or can be entirely different from one another, and the effect includes, but is not limited to, an improvement, enhancement, advancement, refinement, etc. that one digital content has over the other digital content, or an opposite of an improvement, enhancement, advancement, refinement, etc., or no difference between two digital contents.

As used herein, “digital content” or any variations thereof refer to any digital media, including, but not limited to, any website, any email, any graphic, any video, any audio, any text, any computer program, and/or any other type of digital media and/or any combinations thereof.

As used herein, “variation of digital content” or variations thereof refer to any changes, alterations, modifications, deletions, updates, etc. made to a digital content so that the changed, altered, modified, deleted, updated, etc. digital content is different from its previous iteration.

As used herein, “designers of the test”, “test designers”, “designers of A/B test”, “A/B test designers” or any variations thereof refer any developers, designers, creators, etc. and/or any other users that develop, design, create, etc. an A/B test, a test, an A/B experiment, an experiment or any variations thereof.

The rapid growth and commoditization of experimentation platforms has meant that today, developers, product managers, marketers, analysts, designers, and business leaders all have easy access to tools to conduct A/B tests. While this ubiquity has led to the growth of data-driven decision-making within organizations, it also means that users of experimentation tools, with a limited understanding of the nuances of statistical inference, have access to powerful tools that can lead them astray if used improperly. This democratization of A/B tests requires testing solutions that meet the needs of different types of users with different set of skills, while also protecting them from statistically flawed conclusions. In particular it is desirable to monitor these tests continually, stop bad tests early, and/or continue tests to collect more evidence. However, a close monitoring or peeking of tests progression is known to inflate type-I error, i.e., rejecting a null hypothesis when it is true. Performing comparisons multiple times before reaching the sample size and/or collecting more data and performing additional comparisons can drastically inflate the type-I error. Some existing A/B testing tools focus on determining estimands, such as, an average treatment effect (ATE) or individual treatment effect (ITE), which measures causal effects through differences in responses. However, such approaches are problematic as they are dependent on scale of the tests, relative estimated errors, and other parameters that cause erroneous conclusions, such as, for example, inflation of type-I errors.

Embodiments implement an effect determination system that executes an anytime analysis of data being collected and determines an “effect metric” or a “lift metric” (terms used interchangeably herein) at any time during execution of A/B test in order to alleviate problems with existing solutions. Such effect or lift metric indicates an effect that one variation of digital content has over another variation of that digital content (or another digital content). According to one embodiment, the effect determination system receives, as input, accuracy confidence parameter(s) (as determined using any known methodologies) associated with the data being collected and returns as output an estimate of the effect/lift metric and a confidence sequence at any time point requested during the experiment.

In some embodiments, the effect determination system collects data during execution of one or more tests. The effect determination system analyzes the collected data to assess an accuracy level for a given test, such as, an A/B test, among other types of tests. Test designers typically define a set of parameters for such test that is specific to a particular goal. By way of a non-limiting example, the test designers define parameters indicative of whether a website should include a red button or a blue button. Data collected from execution of the A/B test indicates users' preferences of the red vs. blue buttons. The effect determination system assesses accuracy of the test and the collected data using an effect/lift metric. In one embodiment, a processor and/or a network of communicatively coupled processors having one or more computing modules executes this assessment. One of such computing modules includes a test execution or testing module that executes one or more testing sequences. For instance, the testing sequences include a control testing sequence or an A part of the A/B test, and a treatment testing sequence or a B part of the B test. As can be understood, an A/B test may include any number of testing sequences. Each testing sequence prompts users to provide one or more responses to presentation of different variations of digital content. Moreover, the test execution module executes the testing sequences during a predetermined period of time.

By way of a non-limiting example, designers of an A/B test construct the test to test users' responses to an advertising campaign related to a sale in a store by including a control and treatment testing sequences. The control testing sequence (which may or may not be currently used) requests users' responses to the following: “Please use coupon code A for discount on items in our store. The sale ending this Saturday, at 3PM”. The treatment testing sequence (a variation of what is currently being used) requests users' response to the following: “Please use coupon code B for discount on items in our store. The sale ending soon.” In this case, the effect/lift metric more accurately indicates, at any time during the advertising campaigns, which of them is more successful, e.g., whether the users will use coupon code A more often because they know the sale will end at a specific time or whether they will use coupon code B. In another non-limiting example, designers of an A/B test wish to assess user's responses to a color of a button (e.g., red (corresponding to control) vs. blue (corresponding to treatment)) on a website seeking to sign up customers for donations. Here, the effect determination system determines the effect/lift metric to ascertain users' button color preferences more accurately during execution of the testing sequences. As can be understood, A/B tests may be designed in any desired fashion.

As result of execution of the testing sequences, the effect determination system collects test data corresponding to user's responses. Each test data correlates to a specific testing sequence. For example, user 1's response includes clicking of a red button, while user 2's response includes clicking of a blue button. Each such clicking generates various data and/or metadata associated with the clicking. The effect determination system collects this data as the testing sequencies are being executed.

To assess execution of the testing sequences, the effect determination system determines the effect/lift metric during any time period. The effect determination system and/or the test designers randomly select the time period during execution of the testing sequences. Once such time period is selected, the effect determination system, and in particular, its confidence determination module, generates one or more and/or a sequence of confidence intervals. The confidence determination module defines bounds of each confidence interval using the collected data (i.e., users' responses). The confidence determination module generates at least one confidence interval for the first or control testing sequence and at least another confidence interval for the second or treatment testing sequence.

The effect determination system, and in particular, its analysis module, determines one or more effect intervals based on the confidence intervals generated for the test data responsive to the first or control testing sequence and the confidence intervals generated for the test data responsive to the second or treatment testing sequence. The effect intervals include bounds that bound the testing metric. In one embodiment, the analysis module determines each confidence interval for each first test data based on lower and upper bounds of the first test data. Likewise, the analysis module determines each confidence interval for each second test data based on lower and upper bounds of the second test data. The analysis module determines a lower bound of each effect interval using a ratio of a lower bound of a confidence interval for the second test data and an upper bound of each confidence interval for the first test data. The analysis module determines an upper bound of each effect interval using a ratio of an upper bound of confidence interval for the second test data and a lower bound of confidence interval for the first test data. The analysis module performs this determination at any time before conclusion of execution of the testing sequences to indicate the effect of data responsive to execution of the treatment testing sequence over data responsive to execution of the control testing sequence.

In some example embodiments, the effect/lift metric indicates a superiority or an inferiority of the data responsive to the execution of the treatment testing sequence over the control testing sequence. For example, the metric indicates that the users prefer use of a blue button (i.e., treatment) over the red button (i.e., control), or alternatively, the metric indicates that users prefer use of a red button (i.e., control) over the blue button (i.e., treatment).

Based on the determined effect/lift metric, the designers have an option to select content corresponding to data responsive to the treatment or content corresponding to the control testing sequences and terminate the test. Alternatively, or in addition, the designers allow the test to continue until completion. Moreover, the effect determination system performs determination of the effect/lift metric without pausing of the execution of the testing sequences, thereby allowing assessment of collected data at any time and with confidence and reducing the possibility of encountering type-I error.

In some example embodiments, a graphical user interface module communicatively coupled to the effect determination system displays the results of the testing, e.g., in a graph format. The GUI includes a visualization of the confidence intervals for each set of test data, the determined testing metric, and/or any other information. The GUI displays visualizations at any time during the testing. In some example embodiments, the effect determination system terminates the testing upon determination that the testing metric falls outside of the bounds of the effect intervals.

The embodiments provide several advantages and benefits relative to existing testing techniques. For example, conventional solutions suffer from at least the following drawbacks: (1) failure to accurately estimate effects of one digital content variation over another variation in A/B testing, and (2) being prone to type-I error (e.g., stopping tests too early, allowing tests to continue executing when flawed data is being collected, etc.). With respect to the first drawback, the effect determination system implements a process by which it determines precise bounds of an interval containing the effect/lift metric that indicates effects of variations of digital content. The system determines such bounds using confidence interval/sequence data for each data responsive to each digital content variation. Once bounds of the interval are determined, the effect determination system accurately estimates the actual effect/lift metric to indicate effects of the digital content variations. As to the second drawback, determination of precise bounds and accurate estimation of the effect/lift metric allows the designers of the test to check the collected data at any time during execution of the test and be certain that it accurately represents effects of digital content. As a result, if at any time, the determined effect/lift metric falls outside of the bounds, the designers are able to stop execution of the test and make appropriate changes. This greatly reduces occurrence of type-I errors that permeate conventional solutions.

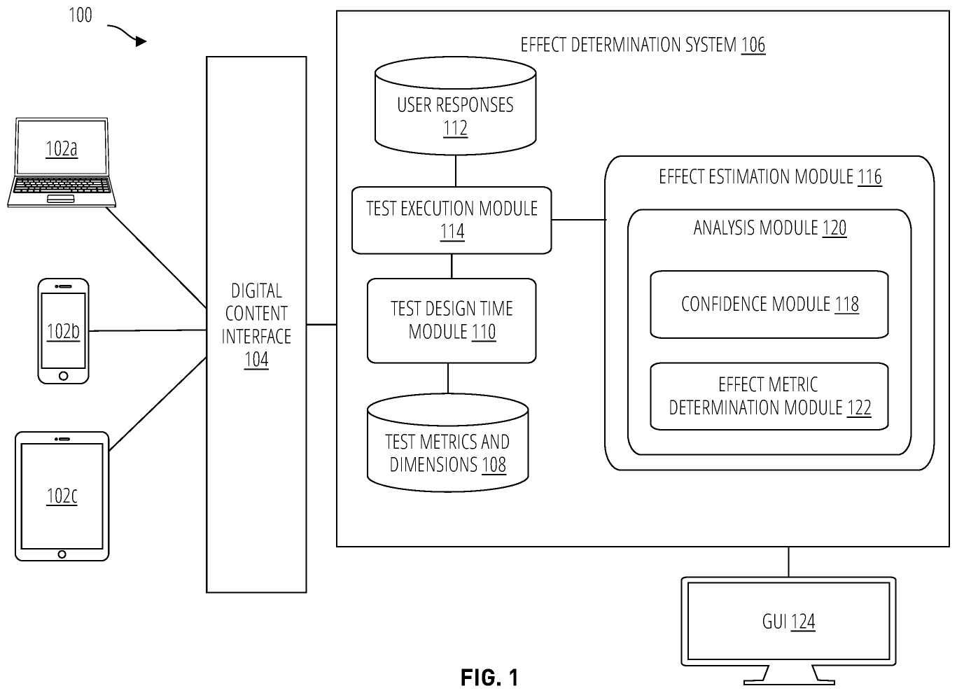

FIG. 1 illustrates an example system 100 for execution of testing designed to ascertain users' responses/reactions/etc. to variations of digital content, according to some embodiments of the current subject matter. In particular, the system 100 confidently determines an effect of one variation of digital content over another variation of that digital content at any time during execution of a user experience experiment or test.

By way of a non-limiting example, in a website setting, the system 100 allows website owners, developers, administrators, etc. to determine users' responses or reactions to a proposed change of a color of buttons on the website. For instance, the buttons are associated with one or more actions, such as, “click this button to proceed with your order”. The proposed change involves changing the current color of the buttons from red to blue. The system 100 allows website administrators (and/or any third parties) to design a test, e.g., an A/B test, to ascertain users' responses to each color (e.g., clicking or not clicking on the button of specific color).

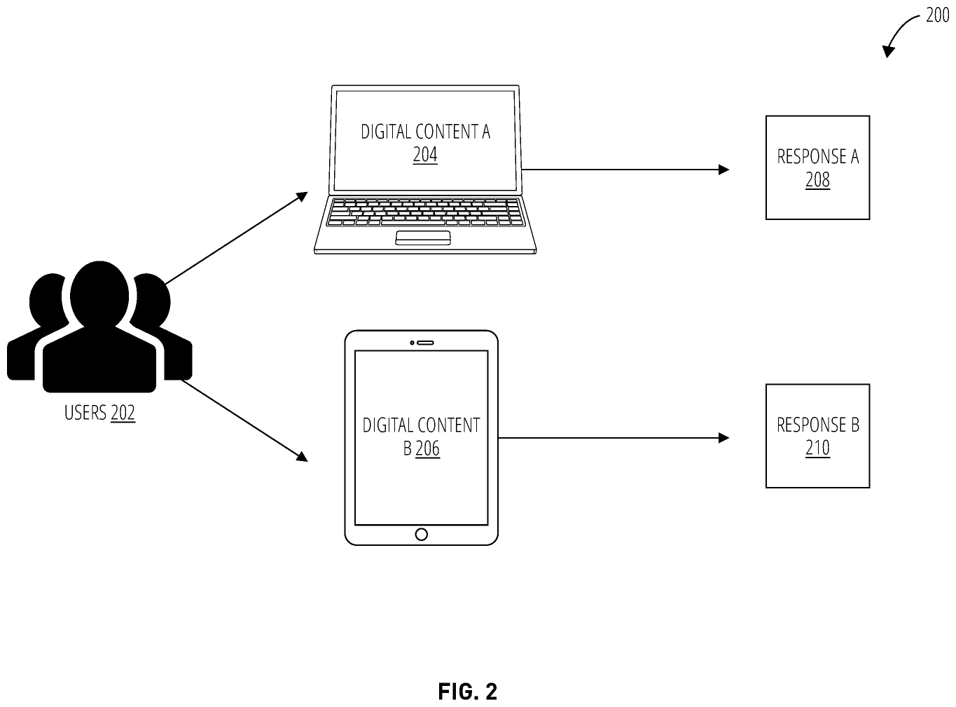

FIG. 2 illustrates an example system 200 configured to execute an A/B test. The A/B test may be designed to receive responses 206, 208 from users 202 to variations 204 and 206 of a particular digital content, respectively. The A/B test includes two parts A and B. In the case of a website and use of different color buttons, the A or control part of the test ascertains user's responses 206 to the use of the red buttons. The B or treatment part of the test ascertains user's responses 208 to the use of the blue buttons. For the purposes of the test, the system 100 randomly selects groups of users exposed to a specific color button. Alternatively, or in addition, the system 100 exposes all users to all color buttons. The system 100 executes the test during a predetermined period of time, e.g., three weeks, etc. During this time, the system 100 collects data related to users' responses and analyzes it in real-time. Further, as discussed herein, the system 100 allows anytime analysis, without pausing of the test, of the gathered data and ascertains the effect of the change from the use of the red button to the use of the blue button.

The system 100 includes an effect determination system 106 communicatively coupled to and/or accessible by one or more user devices 102(a, b, c) via the digital content interface 104. The digital content interface 104 is any interface (e.g., a networking interface, a server interface, an application programming interface, etc., and/or any combination of interfaces) that connects the effect determination system 106 with the user devices 102(a, b, c). The digital content interface 104 presents one or more variations of digital content to the users on their user devices 102(a, b, c). The effect determination system 106 includes a test metrics and dimensions storage location 108, a test design time module 110, a test execution module 114, user responses storage location 112, and an effect estimation module 116. The effect estimation module 116 includes a confidence an analysis module 120 having a confidence module 118 and an effect metric determination module 122. The system 100 also includes a graphical user interface (GUI) device 124 communicatively coupled to the effect determination system 106. The GUI 124 displays a visualization of determined effect metric of one variation of digital content over another variation of digital content.

In some example embodiments, one or more components of the system 100 include any combination of hardware and/or software. In some embodiments, one or more components of the system 100 are disposed on one or more computing devices, such as, server(s), database(s), personal computer(s), laptop(s), cellular telephone(s), smartphone(s), tablet computer(s), virtual reality devices, and/or any other computing devices and/or any combination thereof. In some example embodiments, one or more components of the system 100 are disposed on a single computing device and/or may be part of a single communications network. Alternatively, or in addition to, such services are separately located from one another. A service includes, but not limited to, a computing processor, a memory, a software functionality, a routine, a procedure, a call, and/or any combination thereof that executes a particular function associated with the current subject matter lifecycle orchestration service(s).

In some embodiments, the system 100's one or more components include network-enabled computers. As referred to herein, a network-enabled computer includes, but is not limited to, a computer device, or communications device including, e.g., a server, a network appliance, a personal computer, a workstation, a phone, a smartphone, a handheld PC, a personal digital assistant, a thin client, a fat client, an Internet browser, or other device. One or more components of the system 100 also include, but not limited to, mobile computing devices, for example, an iPhone, iPod, iPad from Apple® and/or any other suitable device running Apple's iOS® operating system, any device running Microsoft's Windows®, mobile operating system, any device running Google's Android® operating system, and/or any other suitable mobile computing device, such as a smartphone, a tablet, or like wearable mobile device.

One or more components of the system 100 include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein. One or more components of the system 100 further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some example embodiments, one or more components of the system 100 execute one or more applications, such as software applications, that enable, for example, network communications with one or more components of system 100 and transmit and/or receive data.

One or more components of the system 100 include and/or be in communication with one or more servers via one or more networks and may operate as a respective front-end to back-end pair with one or more servers. One or more components of the system 100 transmit, for example, from a mobile device application (e.g., executing on one or more user devices, components, etc.), one or more requests to one or more servers. The requests may be associated with retrieving data from servers. The servers receive the requests from the components of the system 100. Based on the requests, servers retrieve the requested data from one or more databases. Based on receipt of the requested data from the databases, the servers transmit the received data to one or more components of the system 100, where the received data may be responsive to one or more requests.

The system 100 include one or more networks. In some embodiments, networks may be one or more of a wireless network, a wired network or any combination of wireless network and wired network and connect the components of the system 100 and/or the components of the system 100 to one or more servers. For example, the networks include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks include, without limitation, telephone lines, fiber optics, IEEE Ethernet 802.3, a wide area network, a wireless personal area network, a LAN, or a global network such as the Internet. Further, the networks support an Internet network, a wireless communication network, a cellular network, or the like, or any combination thereof. The networks further include one network, or any number of the exemplary types of networks mentioned above, operating as a stand-alone network or in cooperation with each other. The networks utilize one or more protocols of one or more network elements to which they are communicatively coupled. The networks translate to or from other protocols to one or more protocols of network devices. The networks include a plurality of interconnected networks, such as, for example, the Internet, a service provider's network, a cable television network, corporate networks, and home networks.

The system 100 include one or more servers, which include one or more processors that maybe coupled to memory. Servers may be configured as a central system, server or platform to control and call various data at different times to execute a plurality of workflow actions. Servers may be configured to connect to the one or more databases. Servers may be incorporated into and/or communicatively coupled to at least one of the components of the system 100.

One or more components of the system 100 execute one or more transactions using one or more containers. In some embodiments, each transaction may be executed using its own container. A container refers to a standard unit of software that may be configured to include the code that may be needed to execute the action along with all its dependencies. This allows execution of actions to run quickly and reliably.

As shown in FIG. 1, the test design time module 110 generates one or more tests based on various test metrics and dimensions retrieved from the storage location 108. Alternatively, or in addition, test designers generate or develop test metrics and dimensions for a particular test. The storage location 108 stores any generated/developed test metrics and dimensions. The test metrics and dimensions include various parameters associated with the test design and its execution. For example, the test metrics and dimensions define, for example, what digital content (e.g., a red button and a blue button) is presented to the users via the digital content interface 104 for testing purposes, the time duration of the test (e.g., 3 weeks) during which users' responses to specific digital content (e.g., different color buttons) are received, a number of users to whom the test is presented, demographics of the users (e.g., specific age group, profession, etc.), as well as any other metrics/dimensions.

The designers of the test use the test design time module 110 to alter the tests and/or to update one or more parameters of the test. For example, during execution of the test, its designers determine that it will be helpful to obtain response data from a larger group of users than originally thought. Hence, the designers modify the test metrics and dimensions accordingly. The test design time module 110 then generates an updated testing sequence. The effect determination system 106 presents the test to an updated group of users. By way of another non-limiting example, the designers of the test may determine that duration of the test should be changed (e.g., shortened, lengthened, etc.). As such, test metrics and parameters related to duration of the test may be appropriately modified.

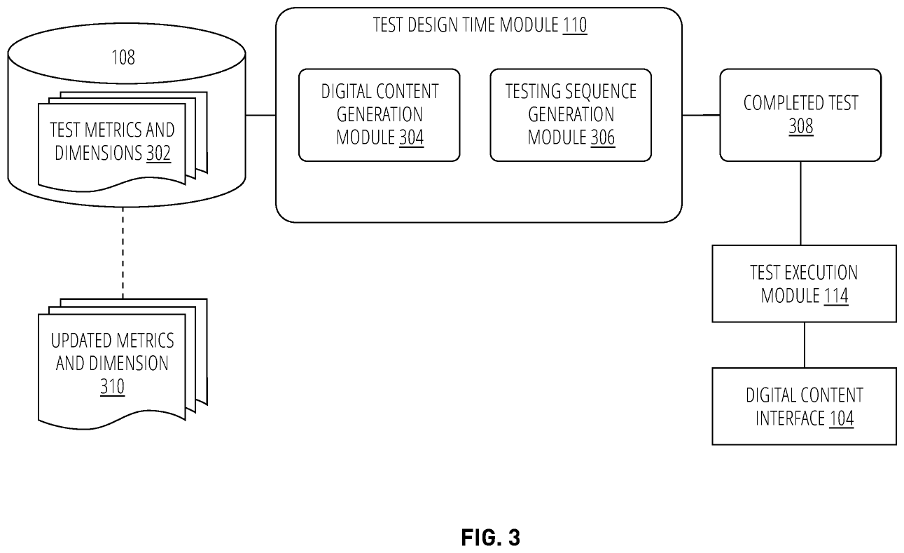

FIG. 3 illustrates further details of the test design time module 110. As stated above, the test design time module 110 generates a test, such as, an A/B test, based on one or more test metrics and dimensions 302 stored in the test metrics and dimensions storage location 108. The test design time module 110 includes a digital content generation module 304 and a testing sequence generation module 306.

The digital content generation module 304 generates one or more variations of the digital content used in the completed A/B test 308. In the above website example, the digital content generation module 304 generates a red button digital content variation and a blue button digital content variation for use on the website. The module 304 generates such digital content variations using test metrics and dimensions 302 received from the storage location 108. In some example embodiments, the module 304 generates an appropriate code (e.g., website code) for each variation of digital content, which will be presented to the users. Alternatively, or in addition, the test design time module receives pre-generated variations of digital content (e.g., one website page having a red button and another website page having a blue button) from an external source (not shown in FIG. 3).

The testing sequence generation module 306 generates one or more testing sequences using the test metrics and dimensions 302. In some embodiments, each testing sequence includes one or more triggers that prompt users (to whom digital content variations are presented) to provide an appropriate response. In the website example, the triggers include a prompt to press a button (“Press button to donate”). The testing sequence generation module 306 generates one or more such testing sequences for each variation of digital content generated by the digital content generation module. Alternatively, or in addition, the testing sequence generation module generates a single testing sequence for all variations of digital content. The testing sequences

Once variations of digital content and testing sequence(s) are generated, the test design time module 110 generates a complete test 308. The test design time module 110 provides the generated complete test 308 to the test execution module 114. The test execution module 114 executes the test 308 and the digital content interface 104 presents the complete test 308 to the users 102 (not shown in FIG. 3).

In some embodiments, as discussed above, the designers of the test can determine that an update to the generated test is required. For example, the update can include a new group of users, a different variation of the digital content (e.g., different hues for the red and blue buttons, etc.) and/or any other type of updates. As such, the test design time module 110 receives updated metrics and dimensions 310 and updates the previously generated test accordingly to generate an updated version of the test and/or a new test.

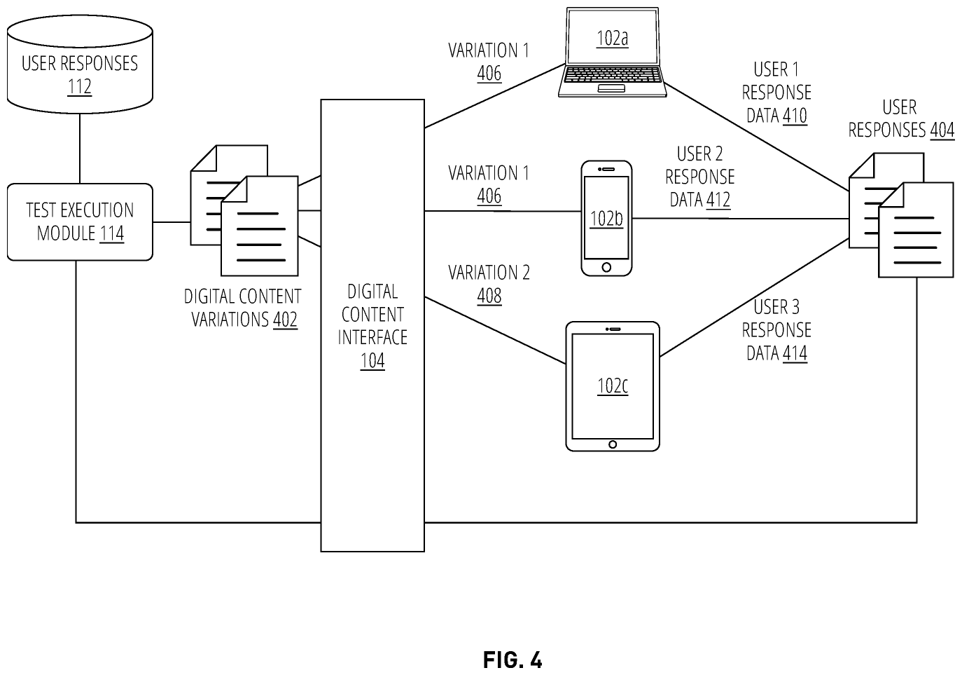

As stated above, once the test has been designed and variations of digital content have been appropriately defined, the test execution module 114 executes the test. In particular, as shown in FIG. 4, as part of test execution, the test execution module 114 causes presentation of defined variations 402 of digital content on graphical user interfaces of user devices 102(a, b, c) via the digital content interface 104. In some embodiments, the test execution module 114 presents different variations of digital content to different groups of users. For example, users of devices 102a and 102b receive and view one variation (“variation 1”) of digital content (e.g., red button on the website) 406. user of device 102c receives and views another variation (“variation 2”) of digital content (e.g., blue button on the website) 408. Alternatively, or in addition, the test execution module 114, via the digital content interface 104, exposes all users of devices 102(a, b, c) to all content regardless of user groups.

Once content is presented on graphical user interfaces of devices 102(a, b, c), the users respond or react to the variations of digital content (e.g., in case of the buttons, click or not click on the buttons). For example, the device 102a responds to the variation 406 of the digital content by generating user 1 response data 410, e.g., the user of device 102a clicks on the red button and device 102a generates an appropriate data, metadata, etc. encapsulating user's click of the red button. Similarly, the device 102b responds to the same variation 406 of the digital content by generating user 2 response data 412, e.g., the user of device 102b does not click on the red button. Likewise, the device 102c generate user 3 response data 414 in response to the variation 408 of the digital content, e.g., user clicks on the blue button.

The test execution module 114, via the digital content interface 104, receives user responses 404, which encompass user 1 response data 410, user 2 response data 412, and user 3 response data 414. The module 114 also stores user responses 404 in the user responses storage location 112. It also provides user responses 404 to the effect determination module 106 for processing and analysis (not shown in FIG. 4). Further, the test execution module 114 continuously receives or monitors and stores users' responses 404 in the user responses storage location 112. The storage location 112 temporarily and/or permanently stores users' responses to the variations 406, 408 of digital content. As can be understood, the test execution module 114 can generate any number of variations of digital content and provide them to the user devices 102.

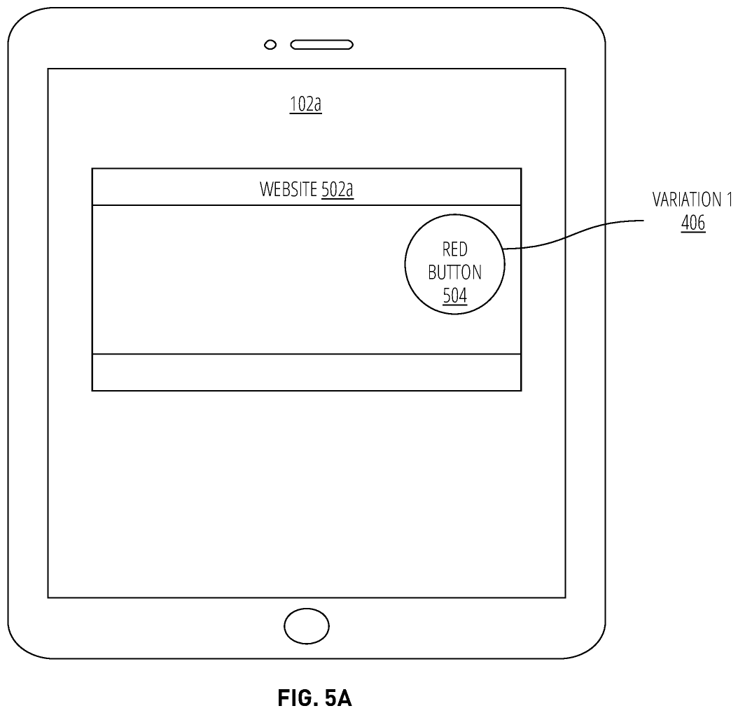

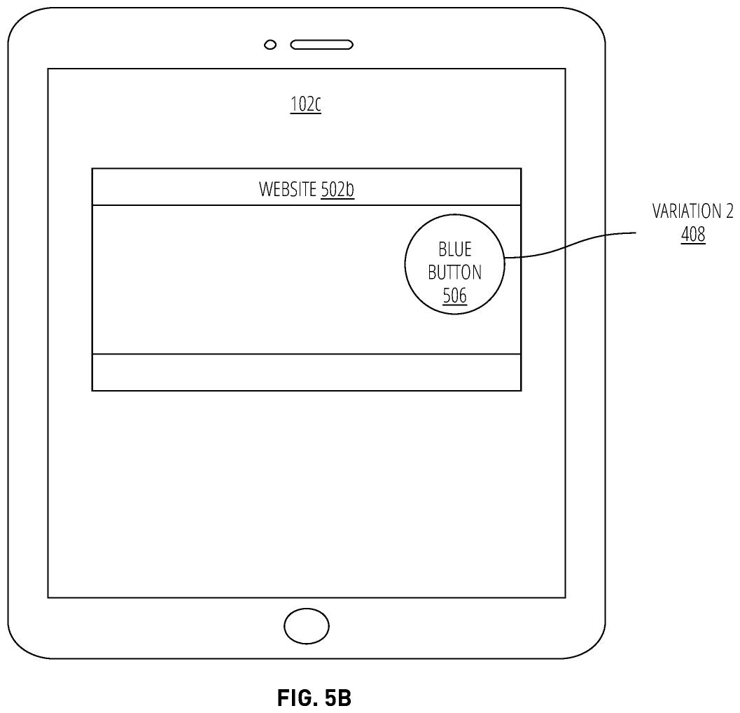

FIGS. 5A-5B illustrate examples of variations of digital content presented to the users on user devices 102, according to some embodiments of the current subject matter.

As shown in FIG. 5A, the test execution module (not shown in FIG. 5A) presents the first variation 406 of digital content (e.g., a red button 504) in a website 502a on the user device 102a. To do so, the user device 102a generates a graphical user interface displaying the website 502a having the red button 504, where the button 504 can serve any desired function (e.g., prompt the user to activate it (e.g., click it, press it, etc.) to place an order, etc.).

As shown in FIG. 5B, the test execution module (not shown in FIG. 5B) presents the second variation 408 of digital content (e.g., a blue button 506) in a website 502b on the user device 102c. Similarly, the user device 102c generates a graphical user interface displaying the website 502b having the blue button 506. The button 506 can execute the same (or different) function as the button 504. The website 502b can be similar and/or different from the website 502a. The users of the devices 102a and 102c can be same or different, and/or can belong to the same and/or different user groups for which the above test is designed.

Referring back to FIG. 1, Once the users activate (e.g., click, press, etc.) and/or do not activate one or more of the buttons 504 and 506 on their respective devices 102a, 102c, the test execution module receives the data related to such activation/non-activation. The activation data includes, for instance, any type of data, metadata, etc., that indicates and/or identifies the user, the user's device, the website that has been accessed, activities conducted on the accessed website, the clicking of the button, time spent on the website, etc. The non-activation data (e.g., the user not pressing the button) is similar to the activation data and reflects that the user has not pressed the button (e.g., blue button 506). The test execution module 114 receives both types of data (e.g., data related to activation and non-activation) and stores as user response data in the user responses storage location 112. In some example, embodiments, the collected data relates to click-through events, conversion events, time spent on the website, time of access to the website, and/or any other data. As can be understood, any other type of data can be collected and can be specific to particular variations of and/or the digital content that is desired to be assessed using a test.

As the test execution progresses, the effect determination system 106 continuously receives the user response data from the test execution module 114. As the data is received, the system 106 then executes an analysis of the received data and determines an effect of one variation of a digital content over another variation of the digital content (e.g., how much more or less likely the users will click on the blue button rather than the red button and vice versa). In one embodiment, the effect estimation module 116 performs such analysis. upon receiving the user responses data. The effect estimation module 116 executes such analysis on continuous basis and/or updates the analysis upon receiving new or further user response data. Alternatively, or in addition, the effect estimation module 116 performs the analysis upon receiving a request. For example, the designer of the test may wish to assess progress of the execution of the test to determine the effect of one variation of the digital content over the other (e.g., how effective is the use of the blue button vs. the use of the red button on the website), and thus, request performance of the analysis.

The effect estimation module 116's analysis module 120 includes the confidence module 118, which uses the gathered user response data to determine one or more confidence intervals and/or sequences of confidence (CS) intervals associated with the data using any known methodologies. The confidence module 118 provides the determined confidence intervals/sequences to the analysis module 120 and the effect metric determination module 122, which determine the effect metric, e.g., an indicator of how effective one variation of digital content is over another variation of digital content. The effect can be a positive effect, e.g., a second or treatment variation of digital content (e.g., blue button) is more effective than a first or control variation of digital content (e.g., red button). The effect can also be a negative effect, e.g., the second or treatment variation of digital content (e.g., blue button) is less effective than the first or control variation of digital content (e.g., red button). Alternatively, or in addition, the effect can be a neutral effect, e.g., no variation is more effective than the other.

In one embodiment, the confidence module 118 determines one or more confidence intervals and/or one or more sequences of confidence intervals during execution of the test. It should be noted that the effect metric is bounded by the bounds of the determined one or more and/or one or more sequences of such confidence intervals. The confidence module 118, during determination of each confidence interval and/or sequence of confidence intervals, accounts for any data that has been received and for which confidence intervals/sequences are/were determined.

In some embodiments, to determine confidence intervals, the confidence module 118 determines (1−α) confidence interval (CI) sequence, Cₜ, Cₜ₊₁, Cₜ₊₂, . . . using the user response data that has been received. The confidence module 118 determines confidence intervals/sequence in such a way that, no matter how many times execution of the test is repeated, the effect metric is guaranteed to be within each confidence interval/sequence at least 100*(1−α)% of repeated test executions. As such, the confidence module 118 determines with high confidence that the effect metric is in all of the confidence intervals over the entire confidence sequence, regardless of how many times the confidence intervals are re-determined using new user responses and/or any user responses resulting from the updates to the test. By way of a non-limiting example, confidence module 118 determines confidence intervals using a known approximation theory of stochastic processes by computing sample means over an infinite time horizon, where approximations of intervals improve as time progresses.

The analysis module 120 further executes an anytime analysis of user response data during execution of the test and, using the effect metric determination module 122, determines an effect metric associated with one variation of digital content over another. The analysis module 120 performs this analysis without pausing execution of the test and relies on a portion of the user response data received at a particular point in time during execution of the test. Alternatively, or in addition, the analysis module 120 performs the analysis using a portion of the user response data received during a specific period of time during execution of the test. The analysis module 120 also updates its analysis upon receipt of new user response data while the test is executing and without affecting the validity of the analysis. As can be understood, the execution of the test may or may not be paused to view any analysis results without affecting validity of the analysis performed by the analysis module 120.

Contrary to historical methods, use of confidence sequences (CS) to address type-I error (associated with peeking) allows use of methods that do not require pre-specifying peeking times at all. A CS for a parameter θ is a sequence C⁻n of sets, such that, Pr(∀n∈N+, θ∈C⁻n)>(1−α). Most of the CS applications focuses on non-asymptotic methods which have three major disadvantages even for fixed-horizon settings: (a) they require strong assumptions, such as a parametric model or known moment generating functions, (b) they are typically wider than asymptotic methods based on the central limit theorem, and (c) they take different forms for different problems, whereas the central limit theorem yields a universal and closed form (trivial-to-compute) expression. To overcome these issues and to satisfy anytime validity requirements, some existing methodologies rely on asymptotic confidence sequences (AsympCS). The effect metric determination module 122 implements one or more aspects of the AsympCS algorithms, as they relate to determination of an average treatment effect (ATE), which is a primary estimand considered in A/B tests. AsympCS for ATE is determined using the following:

$${\overline{C}}_{n}^{Asymp} := ( ( {\check{μ}}_{1 : n} - {\check{μ}}_{0 : n} ) \pm β ( n , α , ρ ) \times \sqrt{\frac{n}{n - 1} [ \frac{n}{{n}_{0}} ( {\hat{σ}}_{0 : n}^{2} + {\check{μ}}_{0 : n}^{2} ) + \frac{n}{{n}_{1}} ( {\check{σ}}_{1 : n}^{2} + {\hat{μ}}_{1 : n}^{2} ) - {( {\hat{μ}}_{1 : n} - {\hat{μ}}_{0 ; n} )}^{2} ]} ) \qquad ( 1 )$$

where

$$β ( n , α , ρ ) = \sqrt{\frac{2 ( n {ρ}^{2} + 1 )}{{n}^{2} {ρ}^{2}}} log ( \frac{\sqrt{n {ρ}^{2} + 1 )}}{α} ) ,$$

and (\hat{μ}_{0;n}, \hat{μ}_{1;n}), and (\hat{σ}_{0;n}, \hat{σ}_{1;n}) are the running means and standard deviations in the two treatment arms (e.g., red button digital content variation and blue button digital content variation). As can be seen from above, Equation (1) depends on individual running counts and sample averages.

To understand a sample size required to reach significance for a given experiment, in a fixed-horizon setting, one or more power calculations which prescribe the necessary size of an experiment are associated with an a priori guess of the population variance of a metric and a desired minimum detectable effect. In the anytime analysis, the hypothesized sample size is determined as follows:

$${inf}_{n} ( Pr ( {θ}_{{H}_{θ}} ∉ {\overline{C}}_{n} \vert {H}_{1} ) >= 1 - β ) \qquad ( 2 )$$

Under H₁ (i.e., a difference in means equal to minimum detectable effect (MDE)), Equation 2 is the same size n* so that the probability of rejecting H₀ is at least 1−β. Here, rejection occurs when the CS C⁻n excludes the null effect θ_{H0} (which may be typically zero). Estimations using Equation (2) proceed by replacing & with a prior guess made by the designer of the test, and then noting that the earliest possible time period is entailed by the time at which the β quantile under H₁ is greater than or equal to the 1−α quantile under H₀, and that the CS under the null and alternate hypotheses are monotonic with respect to n. Equation (2) is then solved using a simple convex optimization problem implementing standard root finding procedures.

While the ATE is a common target estimand, test designers are often interested in estimating the relative treatment effect (or, as stated above, lift), which is defined as (μ₁/μ₀−1), where μ₀ represents an average data associated with one variation of digital content (e.g., number of clicks on a red button per number of users) and μ₁ represents an average data associated another variation of digital content (e.g., number of clicks on a blue button per number of users). Unfortunately, it is not immediately obvious how an estimator for lift can be expressed based on sample averages, and existing AsympCS techniques cannot be applied. To resolve this, the effect metric determination module 122, as will be further detailed below, executes the following sequence: determine a logarithm of the ratio of the treatment means; determine, assuming X is a continuous random variable, such that Pr(X< [symbol] )=α/2, for a strictly monotonic increasing function g:R→>R, Pr(g(X)<g( [symbol] ))=α/2; generate a one-sided AsympCS for log μᵢ; generate the AsympCS for the difference (log μ₁−log μ₀) via union bounds; and apply another monotonic transformation exp{•} to determine at the AsympCS for the lift as follows:

$${\overline{C}}_{n}^{Lift} := [ \frac{{\hat{μ}}_{1 : n} - {\hat{σ}}_{1 : n} β ( {n}_{1} , α , ρ )}{{\hat{μ}}_{0 : n} - {\hat{σ}}_{0 : n} β ( {n}_{0} , α , ρ )} - 1 , \frac{{\hat{μ}}_{1 : n} - {\hat{σ}}_{1 : n} β ( {n}_{1} , α , ρ )}{{\hat{μ}}_{0 : n} - {\hat{σ}}_{0 : n} β ( {n}_{0} , α , ρ )} - 1 ] \qquad ( 3 )$$

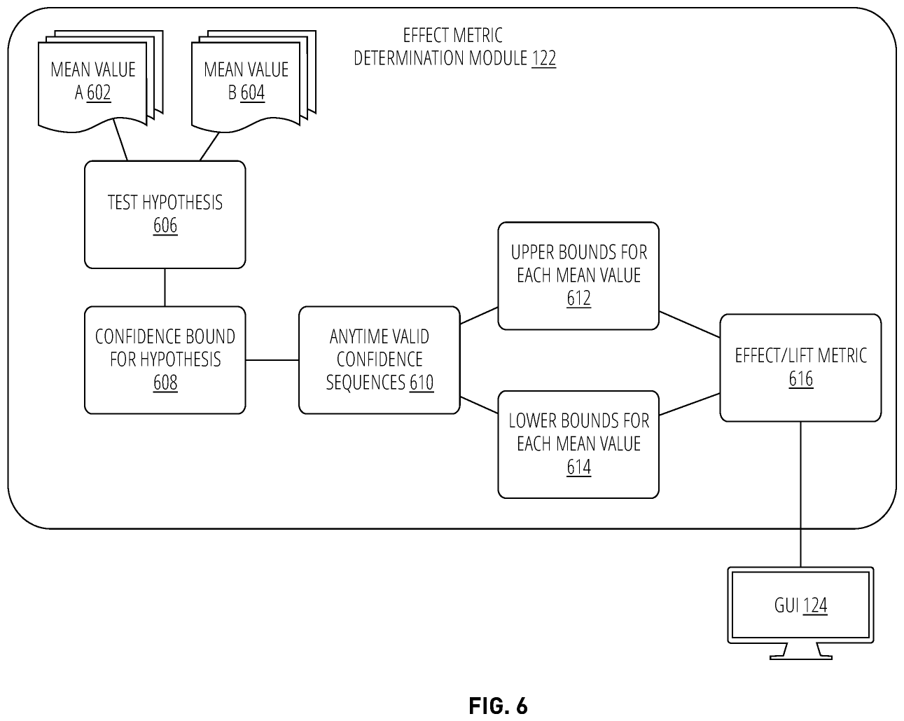

FIG. 6 illustrates details of operation of the effect metric determination module 122. In particular, to determine the effect/lift metric associated with an effect of one variation of digital content over another variation of digital content, the effect metric determination module receives mean (e.g., average) values 602, 604 associated with data representing user responses to variations of content (variation A and variation B), generates a test hypothesis 606 for the mean values, determines one or more confidence bounds 608 for the hypothesis, generates anytime valid confidence sequences 610, computes upper and lower bounds 612, 614 for each data mean value, and determines the effect/lift metric 616 using the computed bounds. As an optional operation, the effect metric determination value transmits the effect/lift metric 616 to the GUI 124 for visualization.

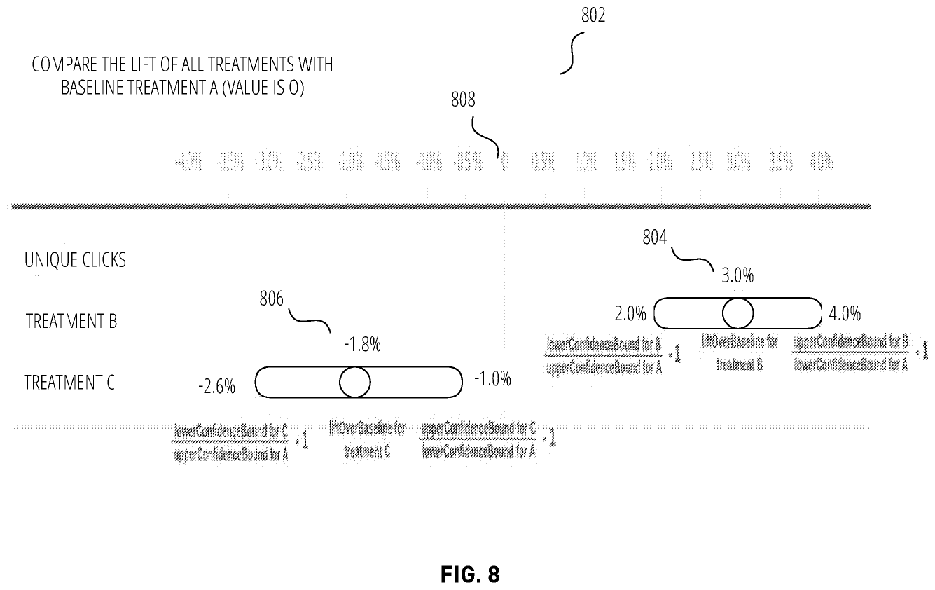

Referring back to the example of two different color buttons on a website, the effect metric determination module 122 receives data representing two mean values A and B 602, 604. As can be understood, any number of mean values can be analyzed by the module 122 (as for example is shown in FIG. 8, where three data values are analyzed and displayed). The mean value A 602 represents data associated with user responses to the red button. The mean value B 604 represents data associated with user responses to the blue button. The module 122 then generates a two-sample hypothesis 606 associated with the test (as executed by the test execution module 114), each sample representing the above mean values. The hypothesis is expressed as follows:

$${H}_{0} : {μ}_{A} = {μ}_{B} vs . {H}_{1} : {μ}_{A} \neq {μ}_{B} \qquad ( 4 )$$

In the above website example, each of the μ_{A} (or μ₀) and μ_{B} (or μ₁) represents a mean value that, for example equals to a number of clicks per number of users associated with a particular variation of digital content (e.g., A (for red button) or B (for blue button)). The above hypothesis can be rewritten as follows:

$${H}_{0} : \frac{{μ}_{B}}{{μ}_{A}} = 1 vs . {H}_{1} : \frac{{μ}_{B}}{{μ}_{A}} \neq 1 \qquad ( 5 )$$

As a result of the above hypothesis, the effect metric determination module 122 then determines a confidence interval/sequence for the effect/lift metric as follows

$$θ = \frac{{μ}_{B}}{{μ}_{A}} - 1 \qquad ( 6 )$$

The effect metric determination module 122 determines a test statistic \hat{θ} and (1−α) confidence bound 608 for θ associated with the hypothesis outlined in Equation (5).

To determine the test statistic \hat{θ}, the module 122 defines a parameter γ=ln (θ+1)=ln μ_{B}−ln μ_{A}, i.e., θ=e^{γ}−1. The module 122 then defines one or more monotonic transformations as part of determining an anytime valid confidence sequence 610 for θ. In particular, assuming X is a continuous random variable, such that: a probability Pr(X< [symbol] )=α/2, then, for a strictly monotonic increasing function g: [symbol] → [symbol] , the module 122 defines a probability Pr(g(X)<g( [symbol] ))=α/2. It should be noted that a strictly monotonic function always has an inverse, g⁻¹(•) over a range of the function [symbol] . Thus, the above probability is expressed as

$$P r ( g ( λ ) < g ( ℓ ) ) = Pr ( X < {g}^{- 1} ( g ( ℓ ) ) ) = Pr ( X < x ) = α / 2 \qquad ( 7 )$$

The module 122 then determines an anytime valid confidence sequence 610 (ACS) for γ, and hence, θ, and applies Equation (7) to determine an anytime valid confidence sequence bounds 612 and 614 for the effect/lift metric θ. In particular, the module 122, for a sequence of random variables X₁, X₂, X₃, . . . Xₙ (e.g., a number of clicks in a website example) with mean μ, such that 2+δ moments exist, for some positive δ, determines a running mean as follows:

$${\hat{μ}}_{n} = \frac{1}{n} \cdot {\sum }_{i = 1}^{n} {X}_{i} \qquad ( 8 )$$

The running mean has the following properties:

$${sup}_{n} Pr ( {\hat{μ}}_{{A}_{n}} - {\hat{σ}}_{{A}_{n}} \sqrt{\frac{2 ( μ {ρ}^{2} + 1 )}{{n}^{2} {ρ}^{2}} log ( \frac{\sqrt{( μ {ρ}^{2} + 1 )}}{α} ) > {μ}_{A} ) = \frac{α}{2}} \qquad ( 9 )$$

$${sup}_{n} Pr ( {\hat{μ}}_{{A}_{n}} - {σ}_{{A}_{n}} \sqrt{\frac{2 ( n {ρ}^{2} + 1 )}{{n}^{2} {ρ}^{2}} log ( \frac{\sqrt{( n {ρ}^{2} + 1 )}}{α} ) < {μ}_{A} ) = \frac{α}{2}} \qquad ( 10 )$$

where \hat{σ}_{A}_{ₙ} is standard deviation. Equations (9) and (10) can be rewritten as

$${\hat{l}}_{{A}_{n}} = {\hat{μ}}_{{A}_{n}} - {\hat{σ}}_{{A}_{n}} \sqrt{\frac{2 ( n {ρ}^{2} + 1 )}{{n}^{2} {ρ}^{2}} log ( \frac{\sqrt{( n {ρ}^{2} + 1 )}}{α} )} \qquad ( 11 )$$

$${\hat{u}}_{{A}_{n}} = {\hat{μ}}_{{A}_{n}} - {\hat{σ}}_{{A}_{n}} \sqrt{\frac{2 ( n {ρ}^{2} + 1 )}{{n}^{2} {ρ}^{2}} log ( \frac{\sqrt{( n {ρ}^{2} + 1 )}}{α} )} \qquad ( 12 )$$

The module 122 then applies probabilities in Equation (7) to Equations (11) and (12) to determine the following supremum functions of probabilities associated with lower and upper bounds as related to data associated with mean value of user responses to the first variation of digital content (i.e., treatment A or red button):

$${sup}_{n} Pr ( ln {\hat{l}}_{{A}_{n}} > ln {μ}_{A} ) = \frac{α}{2} \qquad ( 13 )$$

$${sup}_{n} Pr ( ln {\hat{u}}_{{A}_{n}} > ln {μ}_{A} ) = \frac{α}{2} \qquad ( 14 )$$

Further, the module 122 applies a union bound to determine that the set (ln \hat{l}_{A}_{ₙ}, ln û_{A}_{ₙ}) is a (1−α) anytime valid confidence sequence 610 for the treatment mean μ_{A}. The module 122 similarly defines the ACS 610 for μ_{B} as (ln \hat{l}_{B}_{ₙ}, ln û_{B}_{ₙ}). The module 122 then determines a confidence bound for the difference (ln μ_{B}−ln μ_{A})=γ. To determine the confidence bound for γ, the module 122 sets the maximum possible difference between the two test statistics within the ranges of the two ACS bounds above as the upper bound 612 for γ. As the lower bound 614 for γ, the module 122 sets the smallest possible difference between the two, which corresponds to a standard, conservative way of determining a confidence bound for this difference based on the confidence bounds for the component pieces. Thus, the following is a (1−α) ACS for γ:

$$( ln {\hat{l}}_{{B}_{n}} - ln {\hat{u}}_{{A}_{n}} , ln {\hat{u}}_{{B}_{n}} - ln {\hat{l}}_{{A}_{n}} ) \qquad ( 15 )$$

The module 122 then applies Equation (7) to Equation (15) to determine (1−α) ACS for θ as follows:

$$( {e}^{l n {\hat{l}}_{{B}_{n}} - ln {\hat{u}}_{{A}_{n}}} - 1 , {e}^{ln {\hat{u}}_{{B}_{n}} - l n {\hat{l}}_{{A}_{n}}} - 1 ) \qquad ( 16 )$$

Equation (16), which represents the effect/lift metric 616, can be rewritten as

$$( \frac{{\hat{l}}_{{B}_{n}}}{{\hat{u}}_{{A}_{n}}} - 1 , \frac{{\hat{u}}_{{B}_{n}}}{{\hat{l}}_{{A}_{n}}} - 1 ) \qquad ( 17 )$$

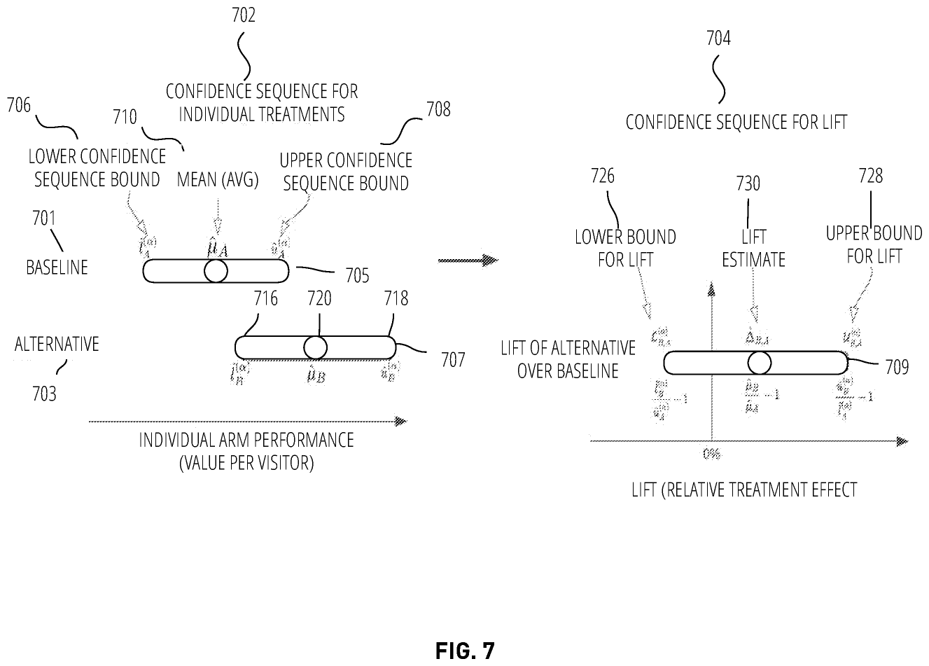

Once the confidence bounds and effect metric are determined, the effect metric determination module 122 transmits both to the graphical user interface 124 for visualization. Examples of such visualization are shown in FIGS. 7 and 8 and discussed below.

FIG. 7 illustrates example graphics 702 and 704 illustrating the effect/lift metric in connection with performance of two treatment arms (e.g., value per visitor or user): arm A 701 and arm B 703. Arm A 701 corresponds to baseline or control (e.g., use of red button in the above website example). Arm B 703 corresponds to alternate or treatment (e.g., use of blue button on the website). The GUI 124 displays graphics 702 and/or 704. The GUI 124 displays these graphics at any time during and/or after execution of the test so that the test designers can assess the data being gathered by the test. Alternatively, or in addition, the GUI 124 displays these graphics after the test designers provide a request to the system 100 to generate such graphics.

In particular, graphic 702 illustrates confidence sequences 705, 707 for each individual arm as bound by lower and upper bounds. The confidence sequence 705 for the baseline arm A 701 has a lower confidence bound 706 and an upper confidence bound 708 that bound a mean (or average) 710 of the performance for the baseline arm A. Similarly, the confidence sequence 707 for the alternate arm B 703 has a lower confidence bound 716 and an upper confidence bound 718 that bound a mean 720 of the performance for the alternate arm B. As can be seen, the lower bound 716 of the confidence sequence 707 for the alternate arm B 703 is greater than the lower bound 706 of the confidence sequence 705 for the baseline arm A 701. Likewise, the upper bound 718 of the confidence sequence 707 for the alternate arm B 703 is greater than the upper bound 708 of the confidence sequence 705 for the baseline arm A 701. Thus, the graphic 702 shows that use of the alternate arm B has some effect over the baseline arm A.

The graphic 704 represents a confidence sequence 709 for the effect/lift metric illustrating a relative treatment effect of the alternate arm B over the baseline arm A. As discussed above, the module 122 uses Equation (16) to determine lower bound 726 and the upper bound 728 of the confidence sequence 709. The module 122 then determines effect/lift estimate 730 using Equation (17). As shown by the graphic 704, the effect/lift estimate 730 indicates that the treatment arm B (e.g., use of a blue button) has an effect (or improvement) vis-à-vis the baseline arm A (e.g., use of a red button).

As can be understood, the current subject matter can determine effect/lift metric for any number of treatments. In that regard, FIG. 8 illustrates an example graphic 802 illustrating comparison of effect/lift metric for multiple treatments over a baseline treatment. The GUI 124 likewise displays the graphic 802 during and/or after execution of the test.

As shown in FIG. 8, graphic 802 illustrates a comparison of an effect/lift metric determined for a treatment B 804 and a treatment C 806 over a baseline treatment A 808 (e.g., having a value of 0). Treatment C has a lower bound (determined as (lower confidence bound for treatment C)/(upper confidence bound for treatment A)−1) that is determined to be at −2.6% and an upper bound (determined as (upper confidence bound for treatment C)/(lower confidence bound for treatment A)−1) that is determined to be at −1.0%. Treatment C's effect/lift metric is determined to be at−1.8%. This indicates that treatment C is not an improvement over the baseline treatment A.

However, the graphic for effect/lift determination for treatment B indicates that treatment B is an improvement of the baseline treatment A. In particular, treatment B has a lower bound (determined as (lower confidence bound for treatment B)/(upper confidence bound for treatment A)−1) that is determined to be at 2.0% and an upper bound (determined as (upper confidence bound for treatment B)/(lower confidence bound for treatment A)−1) that is determined to be at 4.0%. Treatment B's effect/lift metric is determined to be at 3.0%. Since it is greater than the baseline treatment A (i.e., 0%), it is an improvement over the baseline treatment A.

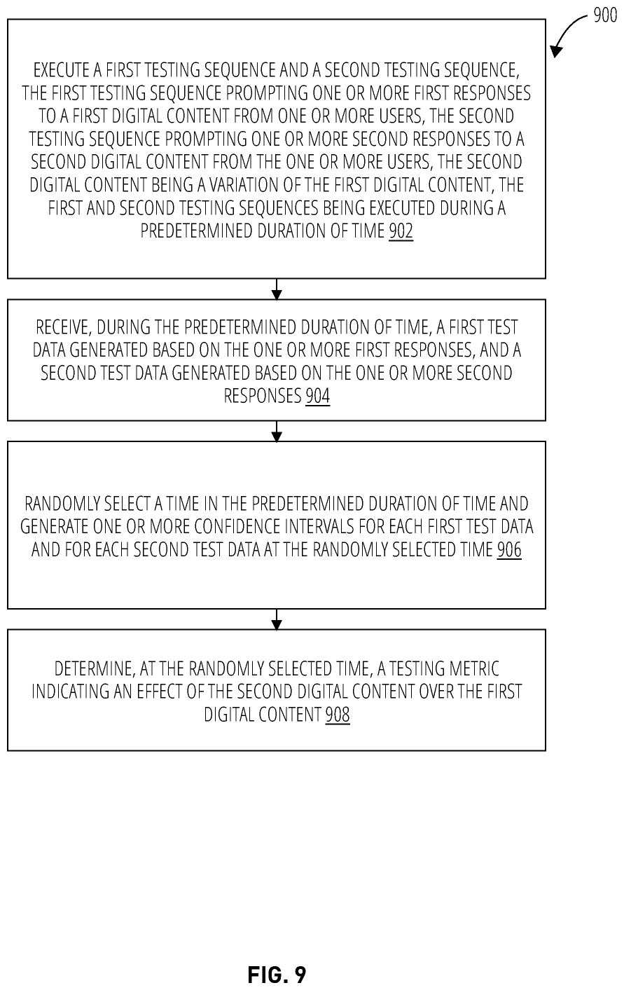

FIG. 9 illustrates an example process 900 for determining an effect/lift metric associated with one variant of digital content vis-à-vis another variant of digital content, according to some embodiments of the current subject matter. The one or more components of system 100 (shown in FIG. 1) executes the process 900 as part of an A/B test.

At 902, the system 100's effect determination system 106, and in particular, its test execution module 114 executes a first testing sequence (e.g., control or A part of A/B test) and a second testing sequence (e.g., treatment or B part of A/B test). The first testing sequence prompts one or more responses 206 (as shown in FIG. 2) to a first digital content (e.g., website, advertising campaign, use of a specific color (e.g., red) button on a website, etc.) from one or more users. The second testing sequence prompts one or more second responses 208 to a second digital content (e.g., variation of website, advertising campaign, use of another color (e.g., blue) button on a website, etc.) from users. As described above, the second digital content is a variation of the first digital content (e.g., blue button vs. red button). In some embodiments, the first and second testing sequences execute during a predetermined duration of time. For example, the testing sequences execute during a period of three weeks, one month, six months, and/or any other desired duration.

In some embodiments, the testing sequences are the same. In alternate embodiments, the testing sequences are different from one another.

Further, the digital contents include, for example, but are not limited to, a website, an email, a graphic, a video, an audio, a text, and/or any other type of digital content, and/or any combination of digital contents. The user responses storage location 112 stores user responses to the digital contents (as shown in FIG. 1). In some example, non-limiting embodiments, the responses include a click, a conversion, a time duration spent on at least one of the first and second digital contents, a time between accessing at least one of the first and second digital contents, and any combination thereof. The digital content(s) is presented to the same and/or different groups of users (e.g., red button digital content is presented to a first group of users, while blue button digital content is presented to a second group of users). The users and/or their groups are randomly generated. The number of users in such groups can be predetermined (e.g., a specific number) and/or can be any number of users (e.g., unlimited, undetermined, etc.).

At 904, the test execution module 114 (as shown in FIG. 1) receives, during the predetermined duration of time, a first test data and a second test data. The first test data corresponds to (or is generated based on) one or more first responses by the users to the first digital content. The second test data corresponds to (or is generated based on) one or more second responses by the users to the second digital content. The test data includes, but is not limited to, any type of data, metadata, etc.

At 906, the confidence module 118 (as shown in FIG. 1) randomly selects a particular time during the predetermined duration of time for determination of an effect/lift metric. The confidence module 118 generates one or more confidence intervals/sequences for each first test data and for each second test data at the randomly selected time. For example, as shown in FIG. 7, the confidence module 118 determines the confidence intervals/sequences of confidence intervals 705 and 707 for each variation of digital content (e.g., for baseline or control (i.e., red button in the website example), and for alternate or treatment (i.e., blue button in the website example)). The confidence intervals/sequences are determined using Equations (7)-(17).

In some embodiments, each confidence interval for each the first and the second data (i.e., user response data to red and blue buttons) is bound by a respective lower bound (i.e., lower bounds 706 and 716, as shown in FIG. 7) and a respective upper bound (i.e., upper bounds 708 and 718) of the first and second test data. Moreover, the confidence module 118 determines each confidence interval/sequence based on the first and second test data received prior to the randomly selected time. This means that the determination of any subsequence confidence intervals/sequences incorporates any data that has been accumulated before as well as determinations of prior confidence intervals/sequences.

At 908, the analysis module 120, and in particular, its effect metric determination module 122, determines a testing metric (i.e., testing metric θ or lift) to illustrate an effect of one variation of digital content over another variation (e.g., use of blue button vs. red button). The module 122 determines the testing metric at any time before expiration of the predetermined duration of time to indicate the effect of the second digital content over the first digital content. An exemplary testing metric or lift is determined using Equation (17) discussed above.

Further, as shown in FIG. 7, the module 122 determines an effect interval (e.g., a confidence sequence 704) for the testing metric based on the bounds of confidence intervals/sequences determined for each variation of digital content. The testing metric is bounded by one or more effect intervals determined by the module 118 based on the confidence intervals generated for the first test data and the confidence intervals generated for the second test data. In particular, the module 122 determines a lower bound of each effect interval using a ratio of a lower bound of each confidence interval for the second test data and an upper bound of each confidence interval for the first test data. Similarly, the module 122 determines an upper bound of each effect interval using a ratio of an upper bound of each confidence interval for the second test data and a lower bound of each confidence interface for the first test data. This is shown by Equation (17) and illustrated in FIGS. 7 and 8.

In some embodiments, the effect of the second digital content over the first digital content indicates at least one of: a superiority of the second digital content over the first digital content (e.g., as shown in FIG. 7 and as illustrated by treatment B over treatment A in FIG. 8) and/or an inferiority of the second digital content over the first digital content (as shown by treatment C over treatment A in FIG. 8). Moreover, one of the first digital content and the second digital content may be selected based on the indicated effect of the second digital content over the first digital content (e.g., use of the blue button may be selected as the winning content). Once selection is made, the execution of the first and second testing sequences may optionally be terminated prior to expiration of the predetermined duration of time and/or expiration of the predetermined duration of time.

In some embodiments, the graphical user interface module 124 communicatively coupled to the effect determination system 106 generates a graphical user interface including a visualization of at least one of: the confidence intervals for each first test data and for each second test data, the determined testing metric, and any combination thereof. The GUI 124 displays the above visualization(s) prior to expiration of the predetermined duration of time. An example of such graphical user interface is shown in FIGS. 7 and 8. In some embodiments, execution of one or both testing sequences may optionally be terminated prior to expiration of the predetermined duration of time upon determining that the testing metric is outside of bounds of one or more effect intervals determined based on the confidence intervals generated for the first test data and the confidence intervals generated for the second test data.

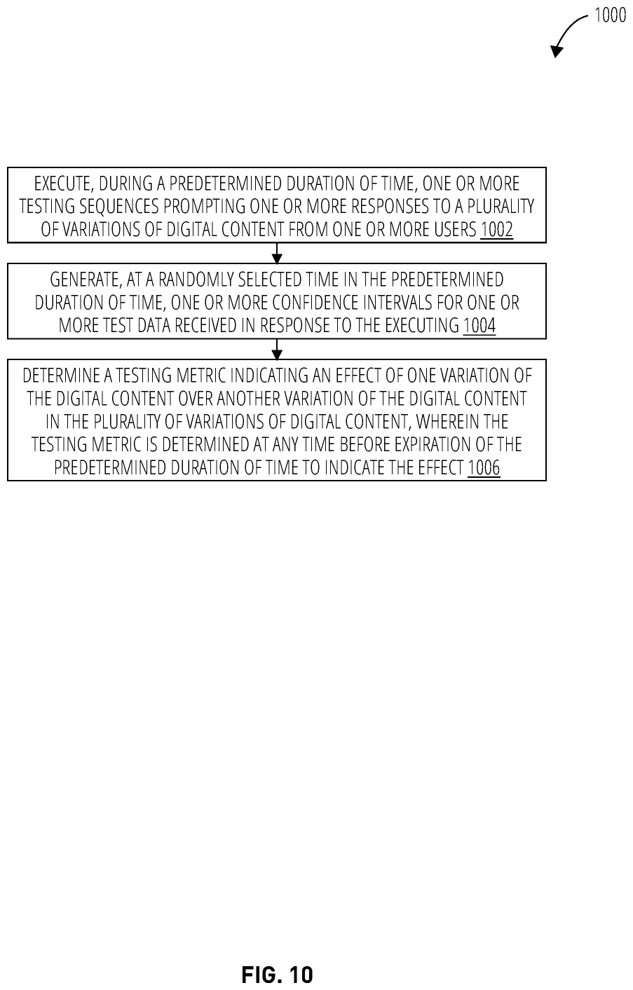

FIG. 10 illustrates another example process 1000 for determining a lift or an effect metric for a variant of digital content, according to some embodiments of the current subject matter. The system 100 shown in FIG. 1 executes the process 1000.

At 1002, the effect determination system 106 of the system 100, as part of an A/B test, executes one or more testing sequences to prompt one or more responses to a plurality of variations of digital content from one or more users. The system 106 executes the testing sequences during a predetermined duration of time. The effect determination module 116 of the system 100 generates one or more confidence intervals for the test data received in response to the execution of the testing sequences, at 1004. The module 116 also determines a testing metric indicating an effect of one variation of the digital content over another variation of the digital content in the plurality of variations of digital content. The module 116 determines the testing metric at any time before expiration of the predetermined duration of time to indicate the effect, at 1006. As discussed above, the testing metric is bounded by one or more effect intervals determined based on the confidence intervals generated for the test data. The module 116 determines each confidence interval for each test data based on lower and upper bounds of the test data.

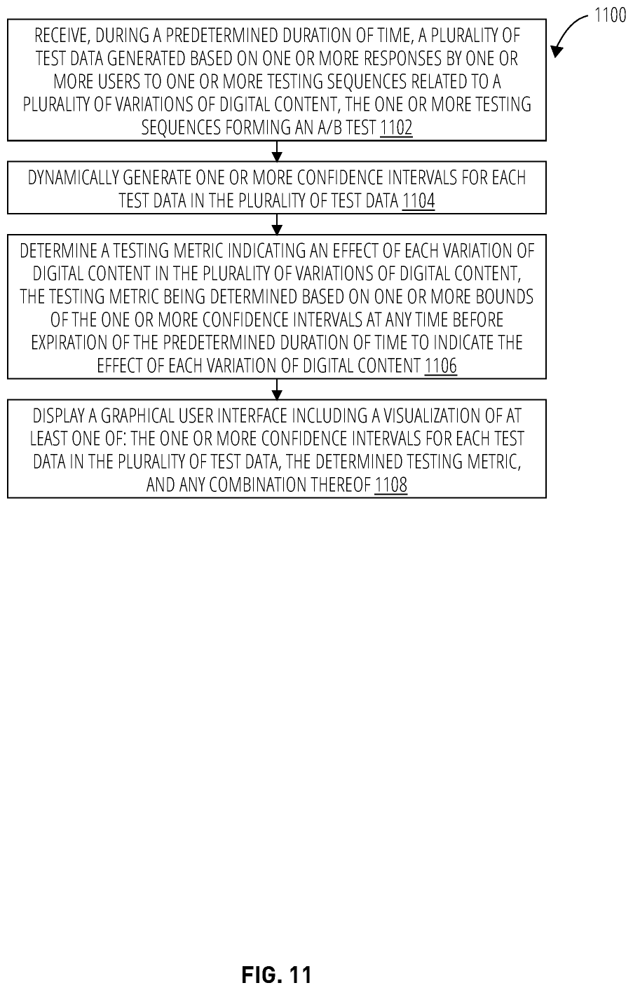

FIG. 11 illustrates another example process 1100 for determining an effect/lift metric to assess effects of variants of digital content, according to some embodiments of the current subject matter. One or more components of system 100 execute the process 1100 to determine such metric.

At 1102, the effect determination system 106 of the system 100 receives a plurality of test data generated based on one or more responses by one or more users to one or more testing sequences related to a plurality of variations of digital content during a predetermined duration of time. The testing sequences form an A/B test. The confidence module 118 of the system 106 dynamically generates one or more confidence intervals for each test data, at 1104. The effect metric determination module 122 determines (e.g., using Equation (17)) a testing metric indicating an effect of each variation of digital content in the plurality of variations of digital content, at 1106. The module 122 determines the testing metric based on one or more bounds of the confidence intervals at any time before expiration of the predetermined duration of time to indicate the effect of each variation of digital content. At 1108, the GUI 124 of the system 100 generates a visualization of at least one of: one or more confidence intervals for each test data in the plurality of test data, the determined testing metric, and any combination thereof. Such visualization may be displayed prior to expiration of the predetermined duration of time.

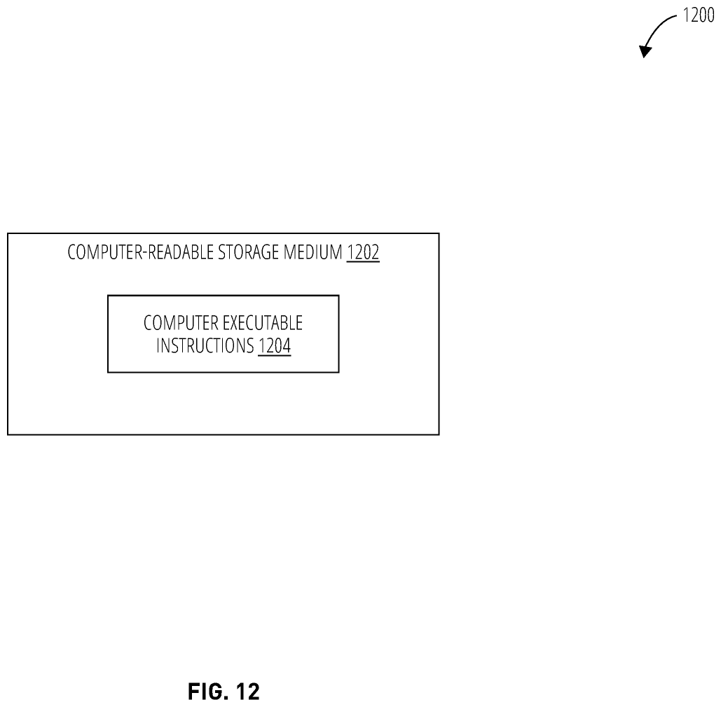

FIG. 12 illustrates an apparatus 1200. Apparatus 1200 comprises any non-transitory computer-readable storage medium 1202 or machine-readable storage medium, such as an optical, magnetic or semiconductor storage medium. In various embodiments, apparatus 1200 comprises an article of manufacture or a product. In some embodiments, the computer-readable storage medium 1202 stores computer executable instructions with which one or more processing devices or processing circuitry can execute. For example, computer executable instructions 1204 includes instructions to implement operations described with respect to any logic flows described herein. Examples of computer-readable storage medium 1202 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1204 include any suitable type of code, such as source code, compiled code, interpreted code, executable code, static code, dynamic code, object-oriented code, visual code, and the like.

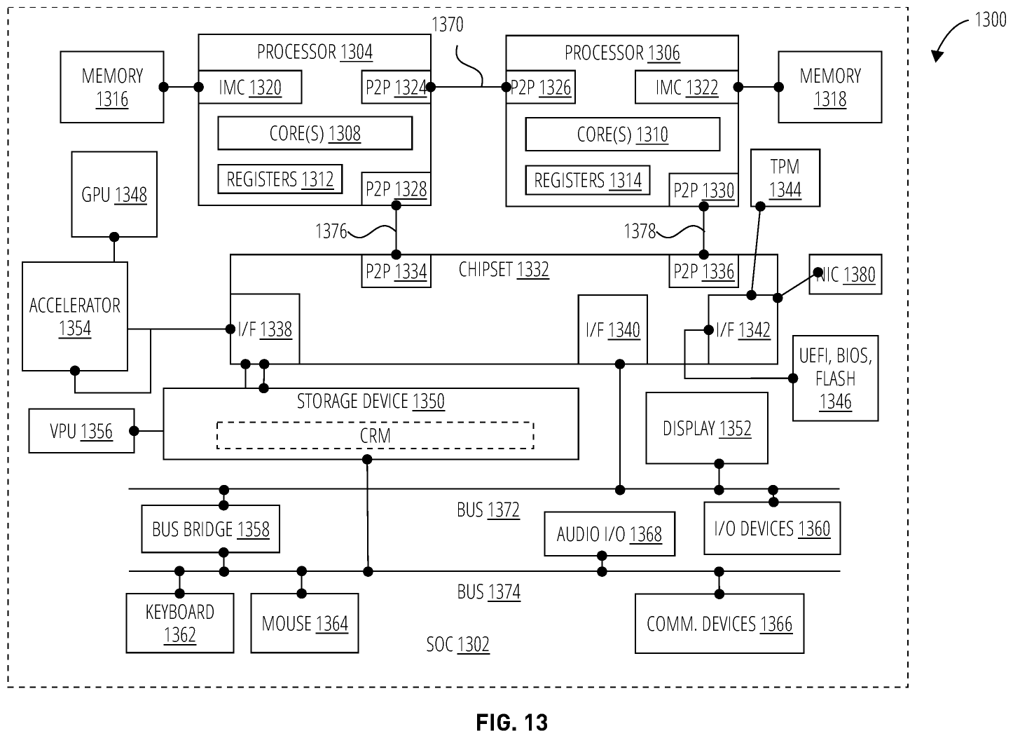

FIG. 13 illustrates an embodiment of a computing architecture 1300. Computing architecture 1300 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1300 has a single processor with one core or more than one processor. Note that the term “processor” refers to a processor with a single core or a processor package with multiple processor cores. In at least one embodiment, the computing architecture 1300 is representative of the components of the system 900. More generally, the computing architecture 1300 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1300. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 13, computing architecture 1300 comprises a system-on-chip (SoC) 1302 for mounting platform components. System-on-chip (SoC) 1302 is a point-to-point (P2P) interconnect platform that includes a first processor 1304 and a second processor 1306 coupled via a point-to-point interconnect 1370 such as an Ultra Path Interconnect (UPI). In other embodiments, the computing architecture 1300 is another bus architecture, such as a multi-drop bus. Furthermore, each of processor 1304 and processor 1306 are processor packages with multiple processor cores including core(s) 1308 and core(s) 1310, respectively. While the computing architecture 1300 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1304 and chipset 1332. Some platforms include additional components and some platforms include sockets to mount the processors and/or the chipset. Furthermore, some platforms do not have sockets (e.g., SoC, or the like). Although depicted as a SoC 1302, one or more of the components of the SoC 1302 are included in a single die package, a multi-chip module (MCM), a multi-die package, a chiplet, a bridge, and/or an interposer. Therefore, embodiments are not limited to a SoC.

The processor 1304 and processor 1306 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1304 and/or processor 1306. Additionally, the processor 1304 need not be identical to processor 1306.

Processor 1304 includes an integrated memory controller (IMC) 1320 and point-to-point (P2P) interface 1324 and P2P interface 1328. Similarly, the processor 1306 includes an IMC 1322 as well as P2P interface 1326 and P2P interface 1330. IMC 1320 and IMC 1322 couple the processor 1304 and processor 1306, respectively, to respective memories (e.g., memory 1316 and memory 1318). Memory 1316 and memory 1318 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1316 and the memory 1318 locally attach to the respective processors (i.e., processor 1304 and processor 1306). In other embodiments, the main memory couple with the processors via a bus and shared memory hub. Processor 1304 includes registers 1312 and processor 1306 includes registers 1314.

Computing architecture 1300 includes chipset 1332 coupled to processor 1304 and processor 1306. Furthermore, chipset 1332 are coupled to storage device 1350, for example, via an interface (I/F) 1338. The I/F 1338 may be, for example, a Peripheral Component Interconnect-enhanced (PCIe) interface, a Compute Express Link® (CXL) interface, or a Universal Chiplet Interconnect Express (UCIe) interface. Storage device 1350 stores instructions executable by circuitry of computing architecture 1300 (e.g., processor 1304, processor 1306, GPU 1348, accelerator 1354, vision processing unit 1356, or the like).

Processor 1304 couples to the chipset 1332 via P2P interface 1328 and P2P 1334 while processor 1306 couples to the chipset 1332 via P2P interface 1330 and P2P 1336. Direct media interface (DMI) 1376 and DMI 1378 couple the P2P interface 1328 and the P2P 1334 and the P2P interface 1330 and P2P 1336, respectively. DMI 1376 and DMI 1378 is a high-speed interconnect that facilitates, e.g., eight Giga Transfers per second (GT/s) such as DMI 3.0. In other embodiments, the processor 1304 and processor 1306 interconnect via a bus.

The chipset 1332 comprises a controller hub such as a platform controller hub (PCH). The chipset 1332 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1332 comprises more than one controller hub such as a chipset with a memory controller hub, a graphics controller hub, and an input/output (I/O) controller hub.

In the depicted example, chipset 1332 couples with a trusted platform module (TPM) 1344 and UEFI, BIOS, FLASH circuitry 1346 via I/F 1342. The TPM 1344 is a dedicated microcontroller designed to secure hardware by integrating cryptographic keys into devices. The UEFI, BIOS, FLASH circuitry 1346 may provide pre-boot code. The I/F 1342 may also be coupled to a network interface circuit (NIC) 1380 for connections off-chip.

Furthermore, chipset 1332 includes the I/F 1338 to couple chipset 1332 with a high-performance graphics engine, such as, graphics processing circuitry or a graphics processing unit (GPU) 1348. In other embodiments, the computing architecture 1300 includes a flexible display interface (FDI) (not shown) between the processor 1304 and/or the processor 1306 and the chipset 1332. The FDI interconnects a graphics processor core in one or more of processor 1304 and/or processor 1306 with the chipset 1332.

The computing architecture 1300 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1354 and/or vision processing unit 1356 are coupled to chipset 1332 via I/F 1338. The accelerator 1354 is representative of any type of accelerator device (e.g., a data streaming accelerator, cryptographic accelerator, cryptographic co-processor, an offload engine, etc.). One example of an accelerator 1354 is the Intel® Data Streaming Accelerator (DSA). The accelerator 1354 is a device including circuitry to accelerate copy operations, data encryption, hash value computation, data comparison operations (including comparison of data in memory 1316 and/or memory 1318), and/or data compression. Examples for the accelerator 1354 include a USB device, PCI device, PCIe device, CXL device, UCIe device, and/or an SPI device. The accelerator 1354 also includes circuitry arranged to execute machine learning (ML) related operations (e.g., training, inference, etc.) for ML models. Generally, the accelerator 1354 is specially designed to perform computationally intensive operations, such as hash value computations, comparison operations, cryptographic operations, and/or compression operations, in a manner that is more efficient than when performed by the processor 1304 or processor 1306. Because the load of the computing architecture 1300 includes hash value computations, comparison operations, cryptographic operations, and/or compression operations, the accelerator 1354 greatly increases performance of the computing architecture 1300 for these operations.

The accelerator 1354 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1354. For example, the accelerator 1354 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1354 via a non-posted write (e.g., a deferred memory write (DMWr)). One example of an instruction that atomically submits a work descriptor to the shared work queue of the accelerator 1354 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1354. The dedicated work queue may accept job submissions via commands such as the movdir64b instruction.

Various I/O devices 1360 and display 1352 couple to the bus 1372, along with a bus bridge 1358 which couples the bus 1372 to a second bus 1374 and an I/F 1340 that connects the bus 1372 with the chipset 1332. In one embodiment, the second bus 1374 is a low pin count (LPC) bus. Various input/output (I/O) devices couple to the second bus 1374 including, for example, a keyboard 1362, a mouse 1364 and communication devices 1366.

Furthermore, an audio I/O 1368 couples to second bus 1374. Many of the I/O devices 1360 and communication devices 1366 reside on the system-on-chip (SoC) 1302 while the keyboard 1362 and the mouse 1364 are add-on peripherals. In other embodiments, some or all the I/O devices 1360 and communication devices 1366 are add-on peripherals and do not reside on the system-on-chip (SoC) 1302.

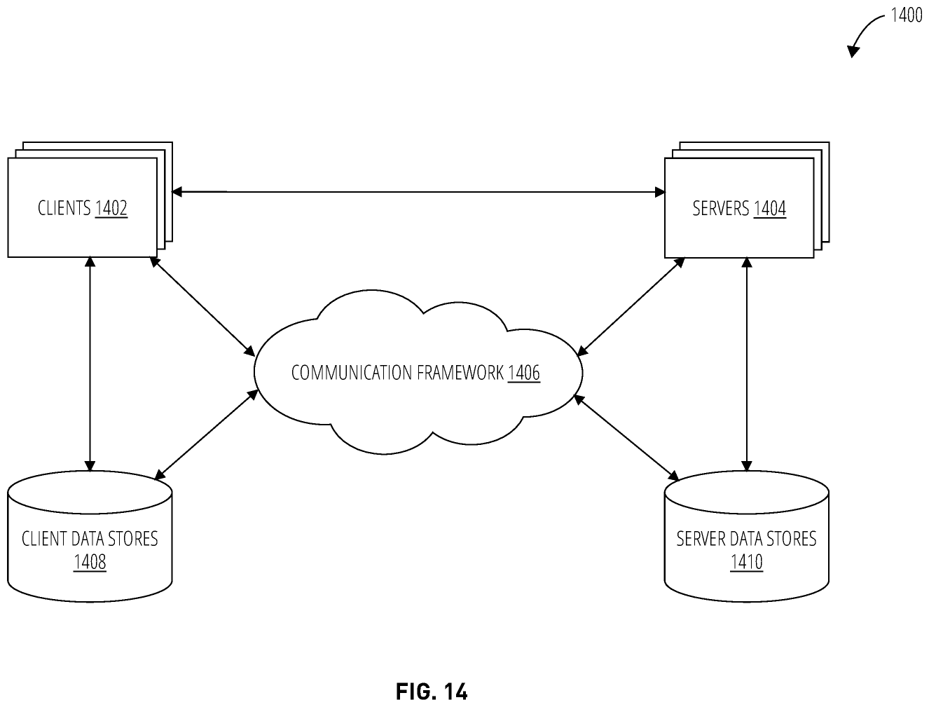

FIG. 14 illustrates a block diagram of an exemplary communications architecture 1400 suitable for implementing various embodiments as previously described. The communications architecture 1400 includes various common communications elements, such as a transmitter, receiver, transceiver, radio, network interface, baseband processor, antenna, amplifiers, filters, power supplies, and so forth. The embodiments, however, are not limited to implementation by the communications architecture 1400.

As shown in FIG. 14, the communications architecture 1400 includes one or more clients 1402 and servers 1404. The clients 1402 and the servers 1404 are operatively connected to one or more respective client data stores 1408 and server data stores 1410 that can be employed to store information local to the respective clients 1402 and servers 1404, such as cookies and/or associated contextual information.

The clients 1402 and the servers 1404 communicate information between each other using a communication framework 1406. The communication framework 1406 implements any well-known communications techniques and protocols. The communication framework 1406 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1406 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/900/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1102 and the servers 1104. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to FIGS. 1-14 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores”, may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writable or rewritable media, digital or analog media, hard disk, floppy disk, Compact Disk Read Only Memory (CD-ROM), Compact Disk Recordable (CD-R), Compact Disk Rewritable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the abstract of the disclosure is provided to allow a reader to quickly ascertain the nature of the technical disclosure. It is submitted with the understanding that it will not be used to interpret or limit the scope or meaning of the claims. In addition, in the foregoing detailed description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the detailed description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

The following examples pertain to further embodiments, from which numerous permutations and configurations will be apparent.

An example method comprises: executing, using a testing module of at least one processor, a first testing sequence and a second testing sequence, the first testing sequence prompting one or more first responses to a first digital content from one or more users, the second testing sequence prompting one or more second responses to a second digital content from the one or more users, the second digital content to comprise a variation of the first digital content, the first and second testing sequences executed during a predetermined duration of time; receiving, using the testing module of the at least one processor, during the predetermined duration of time, a first test data generated based on the one or more first responses, and a second test data generated based on the one or more second responses; randomly selecting, using a confidence module of the at least one processor, a time in the predetermined duration of time and generating one or more confidence intervals for each first test data and for each second test data at the randomly selected time; determining, using an analysis module of the at least one processor, at the randomly selected time, a testing metric indicating an effect of the second digital content over the first digital content; wherein the testing metric is determined at any time before expiration of the predetermined duration of time to indicate the effect of the second digital content over the first digital content.

The example method further comprising any of the previous examples, including, wherein the testing metric being bounded by one or more effect intervals determined based on the one or more confidence intervals generated for the first test data and the one or more confidence intervals generated for the second test data.

The example method further comprising any of the previous examples, including wherein each confidence interval in the one or more confidence intervals for each the first and the second data is determined based on a respective lower bound and a respective upper bound of the first and second test data.

The example method further comprising any of the previous examples, including wherein, at the randomly selected time, a lower bound of each effect interval in the one or more effect intervals is determined using a ratio of a lower bound of each confidence interval for the second test data and an upper bound of each confidence interval for the first test data, and an upper bound of each effect interval is determined using a ratio of an upper bound of each confidence interval for the second test data and a lower bound of each confidence interval for the first test data.

The example method further comprising any of the previous examples, including wherein the effect of the second digital content over the first digital content indicates at least one of: a superiority of the second digital content over the first digital content or an inferiority of the second digital content over the first digital content.

The example method further comprising any of the previous examples, including further comprising selecting one of the first digital content and the second digital content based on the indicated effect of the second digital content over the first digital content; and terminating the executing of the first and second testing sequences at at least one of: prior to expiration of the predetermined duration of time and expiration of the predetermined duration of time.

The example method further comprising any of the previous examples, including wherein the first testing sequence and the second testing sequence form an A/B test.

The example method further comprising any of the previous examples, including wherein the second testing sequence being different from the first testing sequence.

The example method further comprising any of the previous examples, including wherein the second testing sequence being the same as the first testing sequence.

The example method further comprising any of the previous examples, including wherein each next confidence interval in the one or more confidence intervals is determined based on the first and second test data received prior to the randomly selected time.

The example method further comprising any of the previous examples, including wherein the first and second digital contents include at least one of the following: a website, an email, a graphic, a video, an audio, a text, and any combination thereof.

The example method further comprising any of the previous examples, including wherein the one or more first responses and the one or more second responses include at least one of the following: a click, a conversion, a time duration spent on at least one of the first and second digital contents, a time between accessing at least one of the first and second digital contents, and any combination thereof.

The example method further comprising any of the previous examples, including wherein at least one of the randomly selecting and the determining is performed without pausing the executing of at least one of the first testing sequence and the second testing sequence.

The example method further comprising any of the previous examples, including wherein the one or more users includes a predetermined number of users.

The example method further comprising any of the previous examples, including wherein the one or more users includes an undetermined number of users.

The example method further comprising any of the previous examples, including further comprising displaying, using a graphical user interface module communicatively coupled to the at least one processor, a graphical user interface including a visualization of at least one of: the one or more confidence intervals for each first test data and for each second test data, the determined testing metric, and any combination thereof; wherein the displaying is performed prior to expiration of the predetermined duration of time.

The example method further comprising any of the previous examples, including further comprising terminating the executing of at least one of the first and second testing sequence based on the testing metric prior to expiration of the predetermined duration of time upon determining the testing metric being outside of bounds of one or more effect intervals determined based on the one or more confidence intervals generated for the first test data and the one or more confidence intervals generated for the second test data.

An example system, comprising: at least one processor; and at least one non-transitory storage media storing instructions, that when executed by the at least one processor, cause the at least one processor to perform operations including executing, during a predetermined duration of time, one or more testing sequences prompting one or more responses to a plurality of variations of digital content from one or more users; generating, at a randomly selected time in the predetermined duration of time, one or more confidence intervals for one or more test data received in response to the executing; determining a testing metric indicating an effect of one variation of the digital content over another variation of the digital content in the plurality of variations of digital content, wherein the testing metric is determined at any time before expiration of the predetermined duration of time to indicate the effect; wherein the testing metric being bounded by one or more effect intervals determined based on the one or more confidence intervals generated for the one or more test data, each confidence interval in the one or more confidence intervals for each of the one or more test data is determined based on lower and upper bounds of the one or more test data.

The example system further comprising any of the previous examples, including wherein the one or more testing sequences form an A/B test.

An example computer program product comprising a non-transitory machine-readable medium storing instructions that, when executed by at least one programmable processor, cause the at least one programmable processor to perform operations comprising: receiving, during a predetermined duration of time, a plurality of test data generated based on one or more responses by one or more users to one or more testing sequences related to a plurality of variations of digital content, the one or more testing sequences forming an A/B test; dynamically generating one or more confidence intervals for each test data in the plurality of test data; determining a testing metric indicating an effect of each variation of digital content in the plurality of variations of digital content, the testing metric being determined based on one or more bounds of the one or more confidence intervals at any time before expiration of the predetermined duration of time to indicate the effect of each variation of digital content; and displaying a graphical user interface including a visualization of at least one of: the one or more confidence intervals for each test data in the plurality of test data, the determined testing metric, and any combination thereof; wherein the displaying is performed prior to expiration of the predetermined duration of time.

What is claimed:

1. A computer-implemented method, comprising:
executing, using a testing module of at least one processor, a first testing sequence and a second testing sequence, the first testing sequence prompting one or more first responses to a first digital content from one or more users, the second testing sequence prompting one or more second responses to a second digital content from the one or more users, the second digital content to comprise a variation of the first digital content, the first and second testing sequences executed during a predetermined duration of time;
receiving, using the testing module of the at least one processor, during the predetermined duration of time, a first test data generated based on the one or more first responses, and a second test data generated based on the one or more second responses;
randomly selecting, using a confidence module of the at least one processor, a time in the predetermined duration of time and generating one or more confidence intervals for each first test data and for each second test data at the randomly selected time;
determining, using an analysis module of the at least one processor, at the randomly selected time, a testing metric indicating an effect of the second digital content over the first digital content;
wherein the testing metric is determined at any time before expiration of the predetermined duration of time to indicate the effect of the second digital content over the first digital content.

2. The method of claim 1, wherein the testing metric being bounded by one or more effect intervals determined based on the one or more confidence intervals generated for the first test data and the one or more confidence intervals generated for the second test data;
wherein each confidence interval in the one or more confidence intervals for each the first and the second data is determined based on a respective lower bound and a respective upper bound of the first and second test data.

3. The method of claim 2, wherein, at the randomly selected time,
a lower bound of each effect interval in the one or more effect intervals is determined using a ratio of a lower bound of each confidence interval for the second test data and an upper bound of each confidence interval for the first test data, and
an upper bound of each effect interval is determined using a ratio of an upper bound of each confidence interval for the second test data and a lower bound of each confidence interval for the first test data.

4. The method of claim 1, wherein the effect of the second digital content over the first digital content indicates at least one of: a superiority of the second digital content over the first digital content or an inferiority of the second digital content over the first digital content;
the method further comprising
selecting one of the first digital content and the second digital content based on the indicated effect of the second digital content over the first digital content; and
terminating the executing of the first and second testing sequences at at least one of: prior to expiration of the predetermined duration of time and expiration of the predetermined duration of time.

5. The method of claim 1, wherein the first testing sequence and the second testing sequence form an A/B test, wherein the second testing sequence being at least one of: different from the first testing sequence or the same as the first testing sequence.

6. The method of claim 1, wherein each next confidence interval in the one or more confidence intervals is determined based on the first and second test data received prior to the randomly selected time.

7. The method of claim 1, wherein the first and second digital contents include at least one of the following: a website, an email, a graphic, a video, an audio, a text, and any combination thereof;
wherein the one or more first responses and the one or more second responses include at least one of the following: a click, a conversion, a time duration spent on at least one of the first and second digital contents, a time between accessing at least one of the first and second digital contents, and any combination thereof.

8. The method of claim 1, wherein at least one of the randomly selecting and the determining is performed without pausing the executing of at least one of the first testing sequence and the second testing sequence.

9. The method of claim 1, further comprising displaying, using a graphical user interface module communicatively coupled to the at least one processor, a graphical user interface including a visualization of at least one of: the one or more confidence intervals for each first test data and for each second test data, the determined testing metric, and any combination thereof;
wherein the displaying is performed prior to expiration of the predetermined duration of time.

10. The method of claim 1, further comprising terminating the executing of at least one of the first and second testing sequence based on the testing metric prior to expiration of the predetermined duration of time upon determining the testing metric being outside of bounds of one or more effect intervals determined based on the one or more confidence intervals generated for the first test data and the one or more confidence intervals generated for the second test data.

11. A system, comprising:
at least one processor; and
at least one non-transitory storage media storing instructions, that when executed by the at least one processor, cause the at least one processor to perform operations including
executing, using a testing module of the at least one processor, during a predetermined duration of time, one or more testing sequences prompting one or more responses to a plurality of variations of digital content from one or more users;
generating, using a confidence module of the at least one processor, at a randomly selected time in the predetermined duration of time, one or more confidence intervals for one or more test data received in response to the executing;
determining, using an analysis module of the at least one processor, a testing metric indicating an effect of one variation of the digital content over another variation of the digital content in the plurality of variations of digital content, wherein the testing metric is determined at any time before expiration of the predetermined duration of time to indicate the effect;
wherein the testing metric being bounded by one or more effect intervals determined based on the one or more confidence intervals generated for the one or more test data, each confidence interval in the one or more confidence intervals for each of the one or more test data is determined based on lower and upper bounds of the one or more test data.

12. The system of claim 11, wherein, at the randomly selected time,
a lower bound of each effect interval in the one or more effect intervals is determined using a ratio of a lower bound of each confidence interval for the second test data and an upper bound of each confidence interval for the first test data, and
an upper bound of each effect interval is determined using a ratio of an upper bound of each confidence interval for the second test data and a lower bound of each confidence interval for the first test data.

13. The system of claim 11, wherein the effect of the second digital content over the first digital content indicates at least one of: a superiority of the second digital content over the first digital content or an inferiority of the second digital content over the first digital content;
the operations further comprise
selecting one of the first digital content and the second digital content based on the indicated effect of the second digital content over the first digital content; and
terminating the executing of the first and second testing sequences at at least one of: prior to expiration of the predetermined duration of time and expiration of the predetermined duration of time.

14. The system of claim 11, wherein the first testing sequence and the second testing sequence form an A/B test, wherein the second testing sequence being at least one of: different from the first testing sequence or the same as the first testing sequence.

15. The system of claim 11, wherein each next confidence interval in the one or more confidence intervals is determined based on the first and second test data received prior to the randomly selected time.

16. The system of claim 11, wherein the operations further comprise displaying, using a graphical user interface module communicatively coupled to the at least one processor, a graphical user interface including a visualization of at least one of: the one or more confidence intervals for each first test data and for each second test data, the determined testing metric, and any combination thereof;
wherein the displaying is performed prior to expiration of the predetermined duration of time.

17. An apparatus, comprising:
a testing module of at least one processor configured to receive, during a predetermined duration of time, a plurality of test data generated based on one or more responses by one or more users to one or more testing sequences related to a plurality of variations of digital content, the one or more testing sequences forming an A/B test;
a confidence module of the at least one processor configured to dynamically generate one or more confidence intervals for each test data in the plurality of test data;
an analysis module of the at least one processor configured to determine a testing metric indicating an effect of each variation of digital content in the plurality of variations of digital content, the testing metric being determined based on one or more bounds of the one or more confidence intervals at any time before expiration of the predetermined duration of time to indicate the effect of each variation of digital content; and
a graphical user interface communicatively coupled to the at least one processor and configured to display a visualization of at least one of: the one or more confidence intervals for each test data in the plurality of test data, the determined testing metric, and any combination thereof;
wherein the displaying is performed prior to expiration of the predetermined duration of time.

18. The apparatus of claim 17, wherein the testing metric being bounded by one or more effect intervals determined based on the one or more confidence intervals generated for the first test data and the one or more confidence intervals generated for the second test data;
wherein each confidence interval in the one or more confidence intervals for each the first and the second data is determined based on a respective lower bound and a respective upper bound of the first and second test data.

19. The apparatus of claim 18, wherein, at the randomly selected time,
a lower bound of each effect interval in the one or more effect intervals is determined using a ratio of a lower bound of each confidence interval for the second test data and an upper bound of each confidence interval for the first test data, and
an upper bound of each effect interval is determined using a ratio of an upper bound of each confidence interval for the second test data and a lower bound of each confidence interval for the first test data.

20. The apparatus of claim 19, wherein the effect of the second digital content over the first digital content indicates at least one of: a superiority of the second digital content over the first digital content or an inferiority of the second digital content over the first digital content;
the at least one processor
selects one of the first digital content and the second digital content based on the indicated effect of the second digital content over the first digital content; and
terminates the executing of the first and second testing sequences at at least one of: prior to expiration of the predetermined duration of time and expiration of the predetermined duration of time.
